(19) United States
(12) Patent Application Publication
(10) Pub. No.: US 2012/0122731 A1
(43) Pub. Date: May 17, 2012

(54) Screening molecular libraries using microfluidic devices

(76) Inventors: Hyongsok Soh, Santa Barbara, CA (US); Patrick Sean Daugherty, Santa Barbara, CA (US); Sang-Hyun Oh, Minneapolis, MN (US)

(21) Appl. No.: 11/655,055

(22) Filed: Jan. 17, 2007

Related U.S. Application Data
(63) Continuation-in-part of application No. 11/583,989, filed on Oct. 18, 2006, now Pat. No. 7,807,454.

(51) Int. Cl. C40B 30/10; C40B 60/12

(52) U.S. Cl. 506/12; 506/39

(57) ABSTRACT

Screening in a microfluidic device is mediated by a magnetic field that in some manner displaces or otherwise activates the entities of interest. Entities of interest can be identified and/or separated from one or more other components provided to the microfluidic device. Microfluidic devices may have mechanisms that apply a defined magnetic field to a region of the microfluidic device where library members pass through sequentially and/or in parallel.

### CROSS REFERENCE TO RELATED APPLICATIONS

This application is related to U.S. patent application Ser. No. 11/583,989, filed Oct. 18, 2006 and titled “MICROFLUIDIC MAGNETOPHORETIC DEVICE AND METHODS FOR USING THE SAME,” which is incorporated herein by reference for all purposes.

### GOVERNMENT RIGHTS

This invention was made with Government support under contract H94003-05-2-0503 awarded by the Department of Defense. The Government has certain rights in this invention.

### BACKGROUND

The present invention pertains to methods, systems, and apparatus employing microfluidic processing to screen libraries of chemical compounds or biological components (e.g., proteins expressed on a phage or cell membrane).

Rapid and efficient identification of molecular recognition events, and isolation of particular chemical compounds from molecular libraries has become a centerpiece of chemical research and development. This is particularly true in drug discovery where a research organization must rapidly screen vast libraries for “active” or functionally interesting members. When considering the number of different chemical and physical properties that characterize a commercial viable compound, one quickly realizes that there is a combinatorial explosion of candidate molecules. Thus, to consider even a very small fraction of the candidate space (structural and functional) pertinent to a particular commercial endeavor (e.g., identifying potential therapeutic compounds that interact with a particular protein target), one must have a reliable and rapid screening technology.

Screening libraries for members possessing properties of interest is a challenging task. Among the challenges is rapid analysis of potentially vast numbers of compounds—sometimes on the order of 10¹⁵ or more—in a time frame that does not unduly delay the identification of strong candidate compounds. In addition, the screening process must be repeatable, reliable, and accurate. Typically, it requires significant expenditures of resources, including manual effort. Failure to correctly characterize components (false positives or negatives)—even in very low percentages—can lead to dead ends, missed opportunities and wasted resources.

While various techniques are now employed to address these challenges, the ever-increasing need for rapid chemical and biological discoveries requires further innovations in screening technology.

### SUMMARY

In one aspect, the disclosed invention pertains to methods of screening a molecular library for a defined activity or property. Such methods employ a microfluidic device for this purpose and, in certain embodiments, they may be characterized by the following operations: (a) providing a molecular library as an input to the microfluidic device; (b) passing the members of the library through the microfluidic device in a manner that exposes them to a magnetic field at some point during their passage; and (c) detecting or separating members of the molecular library displaced by the magnetic field. Typically, the members of the library possessing the defined activity or property are tagged with a component that responds to magnetic fields. Thus, members of the library possessing the defined activity (e.g., affinity or catalysis) displace relative to their untagged counterparts. This allows them to be separated, amplified and/or detected . While the library members may be introduced to and/or pass through the microfluidics device in many different formats, in certain embodiments at least some of the members of the library are passed through the microfluidic device serially.

In certain embodiments, prior to exposure to the magnetic field, the method involves treating the members of the library with a bi-functional reagent containing (1) a component that selectively binds to members of the library possessing the defined activity or property (e.g., via a particular epitope or pharmacophore) and (2) a component that is sensitive to magnetic fields. In certain embodiments, the method involves treating the members of the library with (1) a first reagent that binds to members of the library possessing the defined activity or property and (2) a second reagent that is sensitive to magnetic fields. In general, providing tagged library members to the microfluidics device includes the case where members are actively tagged within the device and the case in which members are tagged prior to introduction to the device.

The disclosed methods may be employed to screen many different types of molecular libraries. These include molecular libraries comprising populations of cells comprising distinct molecular features, bacteria and yeast cell-based libraries, phage-based libraries, combinatorial libraries of chemical compounds, libraries of oligomers (e.g., peptides or oligonucleotides), and the like.

Another aspect of the disclosed invention pertains to microfluidics systems for screening molecular libraries. Such systems may be characterized by the following features: (a) an input port for receiving the molecular library; (b) a microfluidic flow passage for passing the molecular library in a fluid medium; (c) a magnetic field generating component for applying a magnetic field to at least a region of the microfluidic flow passage; (d) a first region for receiving members of the molecular library substantially deflected by the magnetic field; (e) a second region for receiving members of the molecular library that are not substantially deflected by the magnetic field; and (f) a controller designed or configured to direct members of the molecular library through the microfluidic flow passage. In addition, the system may include a detector for detecting members of the library tagged with the component that responds to the magnetic field.

In addition, the disclosed microfluidics system may be associated with various ancillary systems. One example of such ancillary system is a system for generating the molecular library. Another example is a system for tagging members of a molecular library possessing the defined activity or property with a component that responds to magnetic fields. The system for tagging may employ a bi-functional reagent as described above. The system for tagging may alternatively (or also) employ a first reagent and a second reagent as described above.

In a specific embodiment, an integrated microfluidics system includes (a) a subsystem for tagging members of a molecular library possessing a defined activity or property with a component that responds to magnetic fields; (b) a mechanism for providing the molecular library as an input to a microfluidic device; (c) a mechanism for passing the members of the library through the microfluidic device in a manner that exposes them to a magnetic field at some point during their passage; and (d) a feature for detecting, amplifying and/or separating the displaced members of the molecular library. During passage through the microfluidic device, exposure to the magnetic field will separate those members of the library tagged with the component relative to their untagged counterparts. In certain embodiments, the integrated microfluidics system also includes a library generating system for generating the molecular library. In certain embodiments, the integrated microfluidics system includes a detection mechanism for amplifying and/or detecting members of the library tagged with the component that responds to the magnetic field.

These and other features and advantages of the invention will be described in more detail below with reference to the associated drawings.

### BRIEF DESCRIPTION OF THE DRAWINGS

FIG. 1 is a process flow chart depicting a sequence of operations that may be employed in certain embodiments.

FIG. 2 is a schematic block diagram of a microfluidics system employing a magnetic field to separate active members of a library.

FIG. 3 is a cartoon illustration of interactions between library members and magnetic microparticles as may be employed to prepare the library for analysis in a microfluidic device.

FIG. 4A is a schematic depiction of one type of magnetic deflection chamber in a microfluidic device.

FIG. 4B is a schematic depiction of another type of magnetic deflection chamber in a microfluidic device.

FIGS. 5A-5E are diagrams of various arrangements of peg or pin-type as well as strip and chevron-type magnetic field generating elements in accordance with various embodiments.

FIGS. 6A and 6B are top views of the channels and magnetic field gradient generating structures in two examples of magnetophoretic microfluidics devices.

FIG. 7 is a schematic diagram of a multistage sorting structure in accordance with certain embodiments.

FIG. 8 is a schematic diagram of a fractionating sorting station.

FIG. 9 is a flow chart of operations associated with a cell fractionating sorting device having an integrated cell detector.

FIG. 10 is a diagram showing a multilayer buffer switching sorting device having multiple sorting devices operating in parallel.

FIG. 11A is a generic depiction of a multi-module integrated microfluidics device or system in accordance with certain embodiments.

FIGS. 11B, 11C and 11D are block diagrams showing integrated devices or systems in accordance with various embodiments.

FIG. 12 is a schematic diagram of a peptide library screening and epitope mapping example using a microfluidic sorting device. Bacterial cells displaying peptides complementary to the antibody-binding region are captured on superparamagnetic beads, allowing continous-flow separation by magnetophoresis. The binding population is then either amplified by growth for a further round of labeling and sorting, or plated on solid media to isolate single clones for sequence determination.

FIG. 13 is a series of three graphs showing results of flow cytometric analysis of the CMACS selection: A peptide library was incubated with biotinylated target and subsequently with streptavidin-coated magnetic beads. The library was screened with CMACS for target-binding peptides and the screened clones were amplified overnight. The fraction of target-binding population in the library was analyzed by flow cytometry after incubating them with fluorescently labeled target.

### DETAILED DESCRIPTION

Introduction

As disclosed herein, screening in a microfluidic device is mediated by a magnetic field that in some manner separates or otherwise activates the entities of interest in a library. This may be accomplished by selectively coupling the entities of interest to magnetic particles and then passing the library, including both coupled and uncoupled members, through the microfluidics device. In this manner, functionally interesting members can be identified and/or separated from one or more other components provided to the microfluidic device. As with all screening processes, the microfluidics screening employed in embodiments of this invention may select for members of a library that possess certain characteristics or properties (e.g., they bind to a particular target). Microfluidic devices employed to screen libraries generally will include mechanisms for applying a defined magnetic field and/or magnetic field gradient to a selected region of the device where library members pass through sequentially and/or in parallel.

Typically, the compounds or other entities being screened are not immobilized; e.g., they flow though a microfluidic device. In certain embodiments, the screening is not reliant, at least not principally, on optical techniques or other techniques that do not sort by displacement.

An example system of the present invention delivers a population of cells expressing particular peptide sequence on its cell surface (one example of a “cell surface library”) as an input to a microfluidic device. These cells will have been previously contacted with a bi-functional reagent containing (1) a component that binds to a selected species (e.g., a particular epitope or pharmacophore found on expressed proteins in the cell membrane) and (2) a component that is sensitive to a magnetic field. Of course, the bi-functional reagent could be replaced with two separate reagents that bind to one another. Regardless of the approach taken, at least some cells having the species of interest will be tagged with the component that responds to a field. All cells are passed through the microfluidic device and exposed to a magnetic field at some point during their passage. Those cells that have been tagged will respond differently than those that have not. Specifically, when exposed to the field, the tagged cells may displace relative to their untagged counterparts. The resulting displacement allows the tagged cells to travel to a different portion of the microfluidic device and thereby effect detection and/or separation.

Many different forms of microfluidic devices may be employed in embodiments of this invention. These include devices employing magnetic fields alone or in combination with any other form of driving force for separation. As well, all types of libraries may be employed with the invention; these include phage based libraries, bacterial based libraries, and synthetic libraries including combinatorial chemistry libraries and libraries of synthetic oligomers such as synthetic peptide libraries (employing natural and/or non-natural amino acids) and synthetic oligonucleotide libraries (employing natural and/or non-natural nucleotides), and hybrids containing, e.g., peptide and non-peptide moieties.

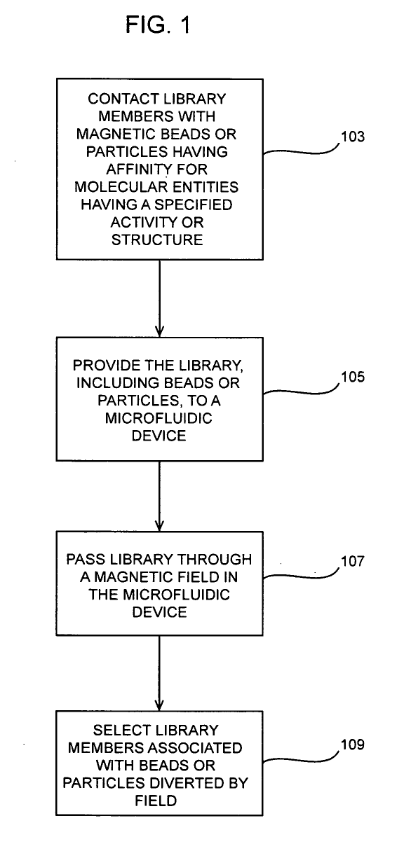

FIG. 1 depicts a process flow as may be employed in certain embodiments. The depicted process flow begins at a block 103 where library members are contacted with magnetic beads or other magnetic particles having affinity for molecular or biological entities of a specified activity or structure. For example, a bacterial display library of at least about 10¹⁰ members is contacted with biotin-tagged target protein and streptavidin coated magnetic beads. Thereafter, as indicated at a block 105 in the flow chart of FIG. 1, the library, including beads or particles, is provided to a microfluidic device. This may involve, for example, injecting or pumping into the device a liquid medium containing the library members and magnetic particles. As the library and magnetic particles pass through the microfluidic device, they encounter a magnetic field. See block 107. As explained more fully below, the field may be generated and/or shaped by permanent magnets, coils through which current is passing, ferromagnetic strips or dots exposed to an external magnetic field, and the like. The magnetic field (more precisely the magnetic field gradient) will impose mechanical force on the magnetic particles and weakly influence (if at all) the free library members; i.e., the members that are not attached to a magnetic field or particle. In certain embodiments, the field causes the magnetic particles to divert from a path through the device that they would otherwise take. Regardless of the exact nature of the field's effect on the magnetic particles, that effect is employed to select library members associated with beads or particles. See block 109.

In certain embodiments, some or all selected library members are selected based on intrinsic magnetic properties. In some cases, the process of FIG. 1 is modified such that it becomes unnecessary to contact the library with magnetic particles. Rather, the magnetic properties of certain library members provide the selectable property. Red blood cells, for example, possess an intrinsic magnetism that can be used for selection. More generally, certain libraries may include members that chelate or otherwise bind magnetic materials. Some microfluidic devices of this invention may be employed assay such libraries.

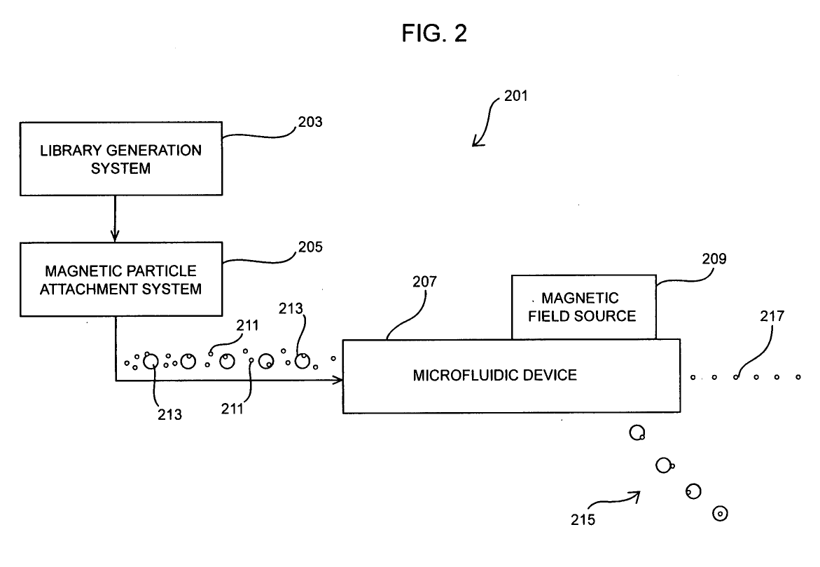

FIG. 2 schematically illustrates a microfluidic system 201 for separating magnetic and non-magnetic entities in a fluid mixture as may be employed in certain embodiments of the invention. In the depicted example, system 201 includes a library generation system 203, which may be, for example, a fluidics device for sequentially generating a combinatorial library of small molecules or oligomers. It may also be a system for performing directed evolution of one or more genes expressing proteins of interest, or a system for generating a bacterial or phage based library.

The library produced by system 203 is passed to a magnetic particle attachment system 205 where it is conjugated with magnetic beads or particles. Within system 205, the library members are allowed to contact magnetic particles in, for example, a liquid medium. During this process, some of the library members having a desired property will bind to magnetic beads. The use of attachment system 205 presupposes that the separation does not rely on intrinsic magnetic properties of library members, in which case it may be unnecessary to employ external beads or particles.

As shown in FIG. 2, the library members and magnetic particles will exit system 205 and be delivered into a microfluidic device 207 containing a magnetic field source 209. As shown, the components exiting system 205 include free library members 211 and bound library members 213, which are attached to magnetic particles. When passing through device 207, a fluid stream including the free and bound members is exposed a magnetic field (and associated magnetic field gradient in certain embodiments) from source 209. As a consequence, the magnetic particles are deflected from the flow of the free library members as indicated by bound members stream 215 and free members stream 217. Thus, the microfluidics device 207 has effected a separation of the free and bound library members. Typically, the members in stream 215 will be analyzed to identify their composition. However, in some embodiments, library members from both of streams 215 and 217 (or stream 217 alone) may be analyzed and identified.

In certain embodiments, the library will be created outside the context of a microfluidics system of this invention. For example, a combinatorial chemical library may be generated on contract with a third party supplier. Alternatively, the library may be generated in house, but then stored for a period of minutes, hours, days or weeks before being presented to a microfluidics device of this invention. Further, a library containing members associated with magnetic particles may be provided outside the context of the microfluidics separation system. In other words, the library may be exposed to magnetic particles in a separate system and later delivered to a microfluidics separation device. In cases such as those described in this paragraph, one or both of library generation system 203 and magnetic particle attachment system 205 in FIG. 2 would not be provided as part of a microfluidics system, or at least would not be an integral component of system 201.

Often a controller will be employed to coordinate the operations of the various systems or sub-systems employed in the overall microfluidic system. Such controller will be designed or configured to direct members of the molecular library through a microfluidic flow passage. It may also control other features and actions of the system such as the strength and orientation of a magnetic field applied to fluid flowing through the microfluidic device, control of fluid flow conditions within the microfluidic device by actuating valves and other flow control mechanisms, mixing of magnetic particles and library members in the attachment system, generating the library in the library generation system, and directing fluids from one system or device to another. The controller may include one or more processors and operate under the control of software and/or hardware instructions.

Libraries and Library Generation

Generally, a molecular library is an intentionally designed collection of chemically distinct species. The library members may be small or large chemical entities of natural or synthetic origin such chemical compounds, supermolecular assemblies, fragments, glasses, ceramics, etc. They may be organic or inorganic. In certain embodiments, they are monomers, oligomers, and/or polymers having any degree of branching. They may be expressed on a cell or virus or they may be independent entities. Because the library will normally be screened, the library designer need not know the structures and/or properties of some or all of the library members. Prior to screening, the designer typically will not know where in the library individual members are located.

Libraries may be designed to explore structural space associated with many different types of desirable functions or properties. In the context of biochemical research, these functions include binding affinity for, e.g., a nucleic acid sequence, a particular antibody or antigen (epitope), a receptor of a target protein or other biomolecule, a co-enzyme, etc., catalytic activity (e.g., enzymatic activity), and the like. Outside the context of biochemical research, many other types of properties may be screened including conductivity, polarizability, morphological features such as pore size, hydrophobicity or hydrophilicity, equilibrium constants (e.g., pKa), chemical complexing strength, susceptibility to magnetic fields, and the like.

As specific examples, the members of a molecular library may be chemical compounds, mixtures of chemical compounds, biological molecules (e.g., peptides, proteins, oligonucleotides, polynucleotides (including aptamers) and combinations of any of these), viruses (e.g., bacteriophages) or cells (e.g., bacteria or yeast) displaying peptides (e.g., antibodies), or biological materials extracted from sources such as bacteria, plants, fungi, or animal (particularly mammalian), cells or tissue or subcelluar components such as organelles (e.g., nuclei, Golgi, ribosomes, mitochondria, etc.). Note that biological molecules such as peptides, proteins, nucleic acids and the like may employ naturally occurring monomers (amino acids and nucleosides), non-naturally occurring monomers, or combinations thereof. When referring to biological polymers, it is intended to include molecules with natural and/or non-natural monomers or moieties. Those of skill in the art will readily recognize the myriad of chemical types (e.g., optical isomers, etc.) that may be employed as non-natural monomers in certain embodiments. In certain embodiments, library members may be “hybrid” molecules that include moieties (or components) from two or more different types of elements listed above. As an example, library members may include a non-amino acid small molecule group covalently attached to a short chain peptides.

The technique employed for generating a library is of course highly dependent on the type library under investigation. Phage and bacterial libraries for expressing genetically diverse components may be generated by well know techniques that employ controlled mutagenesis, directed evolution, etc. Peptide and oligonucleotide libraries may be produced by any suitable process for controlled combinatorial synthesis of oligomers including split and pool synthesis, array based techniques, etc.

At a minimum, a library comprises a collection of at least two different member species, but generally a library includes a number of different species. For example, a library or population typically includes at least about 100 different members. In certain embodiments, libraries include at least about 1000 different members, more typically at least about 10,000 different members. For some applications, the library includes at least about 10⁶ or more different members. However, the invention is useful in much larger libraries as well, including libraries containing at least 10¹⁰ or even 10¹¹ or more members.

Library members may be evaluated for potential activity such as binding interaction with a defined peptide by inclusion in microfluidic screening assays described herein. In general, the invention can be employed to screen for one or more properties of one or more library members. If one or more of the library members is/are identified as possessing a property of interest, it is selected. Selection can include the isolation of a library member, but this is not necessary. Further, selection and screening can be, and often are, accomplished simultaneous.

Generally, the various screening methods and apparatus encompassed by the present invention allow the serial and/or continuous parallel introduction of a plurality of test compounds (library members) into a microfluidic device. In accordance with certain embodiments, some of the library members may be coupled to a bead or particle that responds to a field such as a magnetic or electric field (or field gradient). Once admitted into the device, a compound or other library member is screened based on its response to a field.

Magnetic Particles and Attachment to Library Members

The magnetic particles employed in embodiments of this invention may be magnetic beads or other small objects made from a magnetic material such as a ferromagnetic material, a paramagnetic material, or a superparamagnetic material. The magnetic particles should be chosen to have a size, mass, and susceptibility that allows them to be easily diverted from the direction of fluid flow when exposed to a magnetic field in microfluidic device (balancing hydrodynamic and magnetic effects). In certain embodiments, the particles do not retain magnetism when the field is removed. In one embodiment, the magnetic particles comprise iron oxide (Fe₂O₃ and/or Fe₃O₄) with diameters ranging from about 10 nanometers to about 100 micrometers. However, embodiments are contemplated in which even larger magnetic particles are used. For example, it may be possible to use magnetic particles that are large enough to serve as a support medium for culturing cells.

In certain embodiments, the magnetic particles are coated with a material rendering them compatible with the microfluidics environment and allowing coupling to particular library members. Examples of coatings include polymer shells, glasses, ceramics, gels, etc. In certain embodiments, the coatings are themselves coated with a material that facilitates coupling or physical association with library members. For example, a polymer coating on a micromagnetic particle may be coated with an antibody, nucleic acid, avidin, or biotin.

One class of magnetic particles is the nanoparticles such as those available from Miltenyi Biotec Corporation of Bergisch Gladbach, Germany. These are relatively small particles made from coated single-domain iron oxide particles, typically in the range of about 10 to about 100 nanometers diameter. They are coupled to specific antibodies, nucleic acids, proteins, etc.

Another class of magnetic particles is made from magnetic nanoparticles embedded in a polymer matrix such as polystyrene. These are typically smooth and generally spherical having diameters of about 1 to about 5 micrometers. Suitable beads are available from Invitrogen Corporation, Carlsbad, Calif. These beads are also coupled to specific antibodies, nucleic acids, proteins, etc.

As mentioned, certain embodiments make use of intrinsic magnetic properties of the sample material. In such embodiments, magnetic particles need not be employed. Examples of such materials include erythrocytes, small magnetic particles for industrial applications, etc.

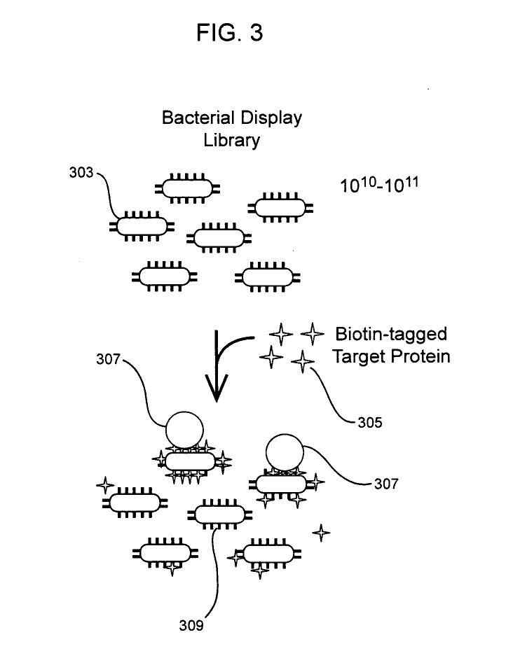

An example of the interactions that lead to coupling in a magnetic particle attachment system is depicted in FIG. 3. As shown in FIG. 3, a bacterial display library 303 having between about 10¹⁰ and 10¹¹ members, each with a different displayed protein, is exposed to (1) a biotin tagged target protein 305 and (2) steptavidin tagged magnetic microparticles. In an alternative approach, the library could be exposed to magnetic particles that already have the target protein directly attached (a bi-functional reagent). The target protein is used to capture library members having a property of interest (affinity for the target protein). In this manner, the members of the library having the property of the interest are selectively tagged. The biotin is used to attach the target protein (in some cases with a bound library member) to the magnetic microparticles. During a period over which the various components in system 205 are permitted to interact, some magnetic microparticles will capture bacteria expressing proteins that bind to the target protein. See microparticles 307 in FIG. 3. Other bacteria, such as bacterium 309 in FIG. 3, will not bind with the target protein because they do not express proteins having an affinity for that protein. When passing the mixture of bound and free bacteria through a magnetic field in microfluidic device 207, the bound bacteria can be isolated with their microparticles.

The library and magnetic particles are typically provided to the microfluidic device in a fluid delivery medium. The fluid should be compatible with the components of the library itself (this is a significant consideration if the library contains cells that could be lysed or other biological materials susceptible to denaturing, etc.). It should also provide a suspension of the magnetic particles with the library members. Depending upon the chemical sensitivity of the library members, the size, mass, and surface properties of the magnetic particles, and flow characteristics of the microfluidic device, fluid media suitable for delivery of the library may include deionized water, saline solutions, buffers, etc. as will be readily understood by those of skill in the art.

The fluid medium may be characterized by a particle density. For example, the fluid medium may comprise magnetic particles in a density of between about 10 to 10¹² particles mL⁻¹ (more typically in the range of about 10⁶ to 10¹⁰).

As illustrated in FIG. 2, a system 205 may be provided for coupling library members to magnetic particles. Such system may employ microscopic and/or macroscopic mixing devices. Examples of micro-mixing devices are presented below. In certain embodiments, system 205 is directly coupled to the microfluidic separation device such that fluidic output from the system 205 flows directly to the microfluidic device. In some cases, system 205 is formed on the same substrate as the components forming microfluidic device 207.

In certain embodiments, system 205 includes a magnetic field generating element that holds the magnetic microparticles stationary, suspended in a flow field of a medium comprising members of the library. As the library members flow past the stationary magnetic particles, some library members become attached to the magnetic particles. After the library has been passed over the magnetic particles, the magnetic field holding the particles in place may be turned off or reduced so that the particles can flow into the microfluidic device and be subject to further separation from the library.

Microfluidics Devices

As indicated above, embodiments of the invention employ microfluidics devices. As used herein the term “microfluidics” conforms in many regards to its broad conventionally understood meaning. Microfluidics devices of this invention may be characterized in various ways. In certain embodiments, for example, microfluidics devices have at least one “micro” channel. Such channels may have at least one cross-sectional dimension on the order of a millimeter or smaller (e.g., less than or equal to about 1 millimeter). Obviously for certain applications, this dimension may be adjusted; in some embodiments the at least one cross-sectional dimension is about 500 micrometers or less. In some embodiments, again as applications permit, the cross-sectional dimension is about 100 micrometers or less (or even about 10 micrometers or less—sometimes even about 1 micrometer or less). A cross-sectional dimension is one that is generally perpendicular to the direction of centerline flow, although it should be understood that when encountering flow through elbows or other features that tend to change flow direction, the cross-sectional dimension in play need not be strictly perpendicular to flow. It should also be understood that in some embodiments, a micro-channel may have two or more cross-sectional dimensions such as the height and width of a rectangular cross-section or the major and minor axes of an elliptical cross-section. Either of these dimensions may be compared against sizes presented here. Note that micro-channels employed in this invention may have two dimensions that are grossly disproportionate—e.g., a rectangular cross-section having a height of about 100-200 micrometers and a width on the order or a centimeter or more. Of course, certain devices may employ channels in which the two or more axes are very similar or even identical in size (e.g., channels having a square or circular cross-section).

In some embodiments, microfluidic devices of this invention are fabricated using microfabrication technology. Such technology is commonly employed to fabricate integrated circuits (ICs), microelectromechanical devices (MEMS), display devices, and the like. Among the types of microfabrication processes that can be employed to produce small dimension patterns in microfluidic device fabrication are photolithography (including X-ray lithography, e-beam lithography, etc.), self-aligned deposition and etching technologies, anisotropic deposition and etching processes, self-assembling mask formation (e.g., forming layers of hydrophobic-hydrophilic copolymers), etc.

In some embodiments, microfluidic devices of this invention are characterized as having at least one cross-sectional dimension in which a magnetic field gradient extends over substantially the entire distance of the dimension. Thus, for example, a microfluidic device channel may have a height of about 100 micrometers over which the magnetic field strength varies significantly. Outside the channel height, the magnetic field strength may or may not vary significantly. This constraint ensures that magnetic entities flowing through the channel will be influenced by the magnetic field gradient. For many microfluidic devices, where the magnetic field strength is on the order of ˜1 Tesla, a magnetic field gradient will diminish significantly beyond about 100 micrometers. However, for much larger magnetic fields such as those on the order of a few Tesla, a magnetic field gradient may extend over a much greater distance, e.g., in the range of a centimeter. Thus, it is within the scope of this invention to employ device channels having relatively large channel cross-sections in which a magnetic field gradient extends substantially the whole way. Generally, when a magnetic field gradient drops below about 10 Tesla/m, it is not viewed as significant. So in certain embodiments, the microfluidic devices of this invention will have a magnetic field gradient of at least about 10 Tesla/m over at least about 90% of a cross-sectional dimension.

In view of the above, it should be understood that some of the principles and design features described herein can be scaled to larger devices and systems including devices and systems employing channels reaching the millimeter or even centimeter scale channel cross-sections. Thus, when describing some devices and systems as “microfluidic,” it is intended that the description apply equally, in certain embodiments, to some larger scale devices.

When referring to a microfluidic “device” it is generally intended to represent a single entity in which one or more channels, reservoirs, stations, etc. share a continuous substrate, which may or may not be monolithic. A microfluidics “system” may include one or more microfluidic devices and associated fluidic connections, electrical connections, control/logic features, etc. Aspects of microfluidic devices include the presence of one or more fluid flow paths, e.g., channels, having dimensions as discussed herein.

In certain embodiments, microfluidic devices of this invention provide a continuous flow of a fluid medium comprising library members. Fluid flowing through a channel in a microfluidic device exhibits many interesting properties. Typically, the dimensionless Reynolds number is extremely low, resulting in flow that always remains laminar. Further, in this regime, two fluids joining will not easily mix, and diffusion alone may drive the mixing of two compounds.

Various features and examples of microfluidic device components suitable for use with this invention will now be described.

(i) Magnetic Field Generating Elements

In various embodiments, magnetic particles are diverted within the microfluidic device via free flow magnetophoresis. In other words, magnetic particles in a continuous flow are deflected from the direction of flow by a magnetic field or magnetic field gradient. In one example, system 205 includes functionality for generating locally strong magnetic field gradients for influencing the direction of movement of the particles in the device. In certain embodiments, strips or patches or particles of materials are fixed at locations within or proximate the flow path of the library members. Specific examples are described below.

The deflection of magnetic particles can be represented as the sum of vectors for magnetically induced flow and hydrodynamic flow. The magnetically induced flow is represented by the ratio of the magnetic force exerted on a particle by the magnetic field (or field gradient) and the viscous drag force. The magnetic force is in turn proportional to the magnetic flux density B (in tesla) and its gradient. It is also proportional to the particle volume and the difference in magnetic susceptibility between the particle and fluid. For a given magnetic field gradient and a given viscosity, the magnetic component deflection is dependent on the size and magnetic susceptibility of the particle.

In certain embodiments, the magnetic flux density (B) applied to a microfluidic channel is between about 0.01 and about 1 T, or in certain embodiments between about 0.1 and about 0.5 T. Note that for some applications, it may be appropriate to use stronger magnetic fields such as those produced using superconducting magnets, which may produce magnetic fields in the neighborhood of about 5 T. In certain embodiments, the magnetic field gradient in regions where magnetic particles are deflected is between about 10 and about 10⁶ T/m. In a specific embodiment that was designed and built, the field gradient was approximately 5000 T/m within 1 micrometer from the edge of a magnetic field gradient generator.

At the point in a microfluidic flow path where separation is to occur, the magnetic field gradient should be oriented in a direction that causes deflection of the particles with respect to the flow. Thus, the magnetic field gradient will be applied in a direction that does not coincide with the direction of flow. In certain embodiments, the direction of the magnetic field gradient is perpendicular to the direction of flow. However, this need not always be the case.

Many different magnetic field generating mechanisms may be employed to generate a magnetic field over the displacement region of the microfluidic device. In a simplest case, a single permanent magnet may be employed. It will be positioned with respect to the flow path to provide an appropriate flux density and field gradient. Permanent magnets are made from ferromagnetic materials such as nickel, cobalt, iron, alloys of these and alloys of non-ferromagnetic materials that become ferromagnetic when combined as alloys, know as Heusler alloys (e.g., certain alloys of copper, tin, and manganese). In one specific embodiment, the permanent magnet is a cylindrical neodymium-iron-boron magnet. In another example, the magnet is an electromagnet such as a current carrying coil or a coil surrounding a paramagnetic or ferromagnetic core. In some embodiments, a controller is employed to adjust the magnetic field characteristics (the flux density, field gradient, or distribution over space) by modulating the current flowing through the coil and/or the orientation of the magnet with respect to the flowing fluid.

In some designs, a combination of magnets or magnetic field gradient generating elements are employed to generate a field of appropriate magnitude and direction. For example, one or more permanent magnets may be employed to provide an external magnetic field and current carrying conductive lines may be employed to induce a local field gradient that is superimposed on the external field. In other embodiments, “passive” elements may be employed to shape the field and produce a controlled gradient. Generally, any type of field influencing elements should be located proximate the flow path to tailor the field gradient as appropriate.

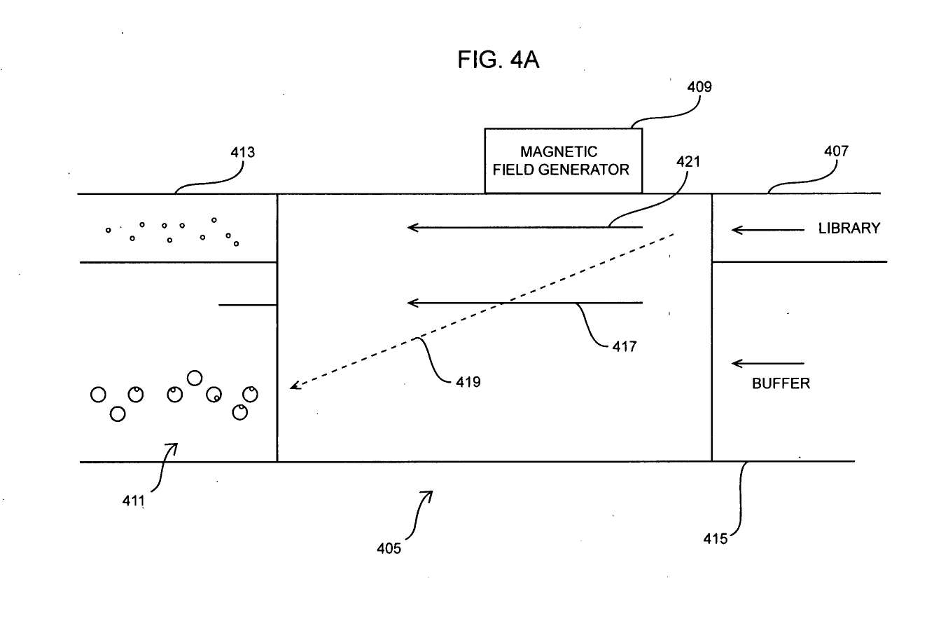

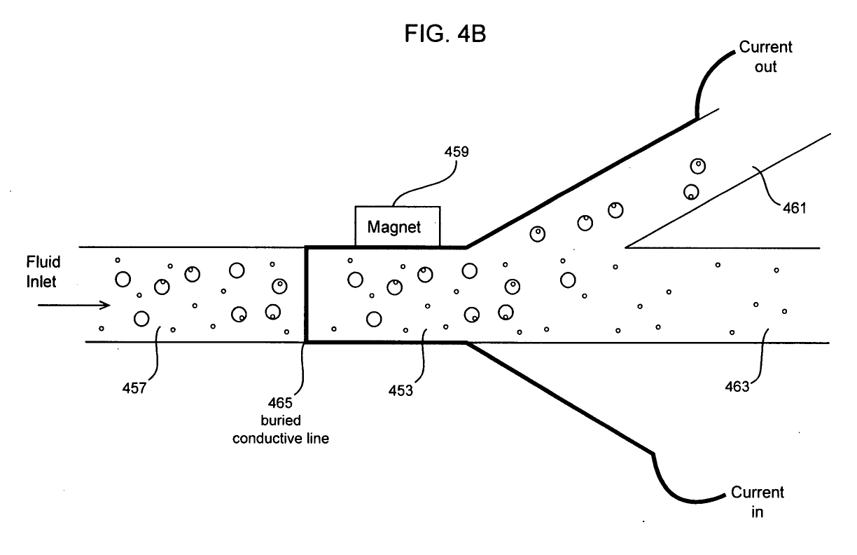

Examples of a separation structures within a microfluidic device of this invention are depicted in FIGS. 4A and 4B. FIG. 4A shows a separation chamber 405 and an associated library inlet channel 407, a magnetic field generating element 409, a magnetic particles outlet channel 411, and a non-magnetic components outlet channel 413. Each of these features is typically provided in a single microfluidic device. In operation, the library and magnetic particles are provided to chamber 405 in a fluid medium via inlet 407. At this stage, the magnetic and non-magnetic components are commingled. A separate buffer solution may be provided to chamber 405 via a parallel inlet 415. Together the buffer and library media flow through chamber 405 in the direction shown by the arrow 417. Magnetic field gradient generating element 409 exerts a lateral force on magnetic particles while in chamber 405 causing them to deflect in the direction of arrow 419. Non-magnetic components of the library continue to flow undeflected with the fluid to outlet 413 as indicated by arrow 421.

FIG. 4B shows an alternative magnetic separation device. This design includes both a magnet for introducing an external magnetic field and a current carrying path for producing a local field gradient. In the depicted embodiment, a fluid containing the library and magnetic particles flows through a microchannel 457 where it encounters a portion of the channel that serves as a separation region 453. Within region 453 an external field is provided by a magnet 459 (permanent or electromagnet) and a local field is produced by current flowing through a buried metal line 465 embedded in the substrate of the device, below the flow channel 457. The local field introduces a magnetic field gradient that, together with the external field, applies a force on the magnetic particles flowing in region 453. At the downstream side of separation region 453 is a branch in the flow channel having one outlet 461 for receiving the magnetic particles (with library members attached in some cases) and another outlet 463 for receiving non-magnetic components of the fluid stream. Thus, magnetic particles flowing in through separator region 453 are diverted toward the outlet 461, while other components are hydrodynamically directed toward outlet 463.

The above embodiments are merely representative, as many other microfluidic structures may be employed to effect separation of magnetic and non-magnetic components in a fluid. Some of these may employ three-dimensional flow paths, buried channels, other combinations of magnetic field generating elements, recirculation loops, etc.

Certain examples of passive magnetic field gradient generators (MFGs) will now be described. As explained, these generally include one or more MFG elements that interact with an external magnetic field to shape the field in a controlled manner, e.g., to produce a local magnetic field gradient of appropriate magnitude and direction. Pertinent parameters of MFG construction include the MFG material(s), the size and geometry of the MFG, and the orientation of the MFG with respect to the fluid flow and external magnetic field.

The material from which an MFG element is made should have a permeability that is significantly different from that of the fluid medium in the device (e.g., the buffer). In certain cases, the MFG element will be made from a ferromagnetic material. Thus, the MFG element may include at least one of iron, cobalt, nickel samarium, dysprosium, gadolinium, or an alloy of other elements that together form a ferromagnetic material. The material may be a pure element (e.g., nickel or cobalt) or it may be a ferromagnetic alloy such as an alloy of copper, manganese and/or tin.

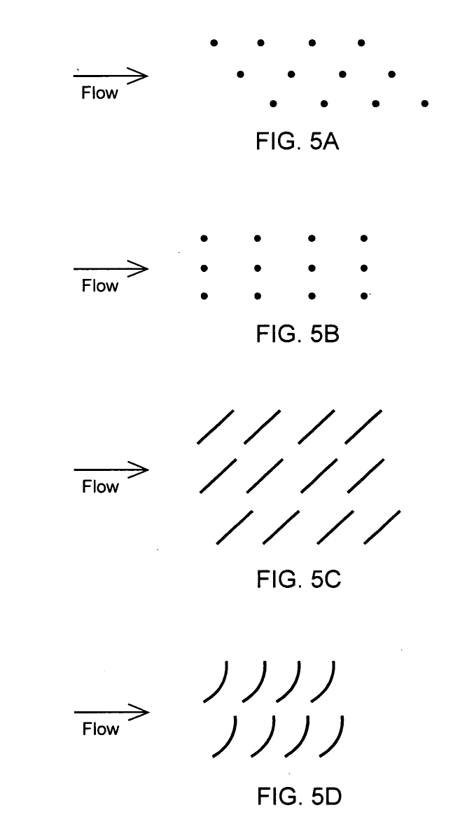

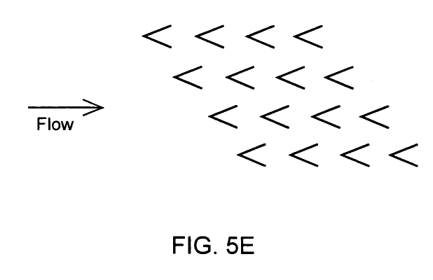

In certain embodiments, the MFG is an array of thin metal stripes (e.g., nickel stripes) micro-patterned on a glass substrate, which becomes magnetized under the influence of an external permanent magnet. Because the stripes possess a higher permeability than the surrounding material (i.e., the buffer), a strong gradient is created at the interface. Although the magnetic flux density from the MFGs may not be strong compared to the surface of the external magnet, the gradient of the magnetic field is very large within a short distance (e.g., a few microns in some embodiments) of the line edges. As a result, the MFGs allow precise shaping of the field distribution in a reproducible manner inside microfluidic channels. The MFG element may include one or more individual magnetizable elements. As shown in FIGS. 5, the MFG may include a plurality of magnetizable elements, e.g., 2 or more, 4 or more, 5 or more, 10 or more, 15 or more, 25 or more, etc.

In designs where the magnitude of the gradient decreases rapidly with distance from the MFG, the MFG may be formed within or very close to the flow channel where sorting takes place. Therefore, in some microfluidic examples, an MFG should be located within a few micrometers of the sorting region where magnetic particles are to be deflected (e.g., within about 100 micrometers or in certain embodiments within about 50 micrometers or within about 5 micrometers of the sorting region, such as within about 2 micrometers of the sorting region). However, when large external fields are employed, the MFG design need not be so limited. Generally speaking, the

MFG may be located as far away from the sorting region as about 10 millimeters. This may be the case when, for example, the external magnetic field is in the domain of about 1 Tesla or higher. Note that the large gradients afforded by such MFGs allow one to design very high throughput sorting stations with relatively large channels and consequently the capability to support large volumetric flow rates.

In certain embodiments, the MFG elements are provided within the sorting region channel; i.e., the fluid contacts the MFG structure. In certain embodiments, some or all of the MFG structure is embedded in channel walls (such as anywhere around the perimeter of the channel (e.g., top, bottom, left, or right for a rectangular channel)). Some embodiments permit MFG elements to be formed on top of or beneath the microfluidic cover or substrate.

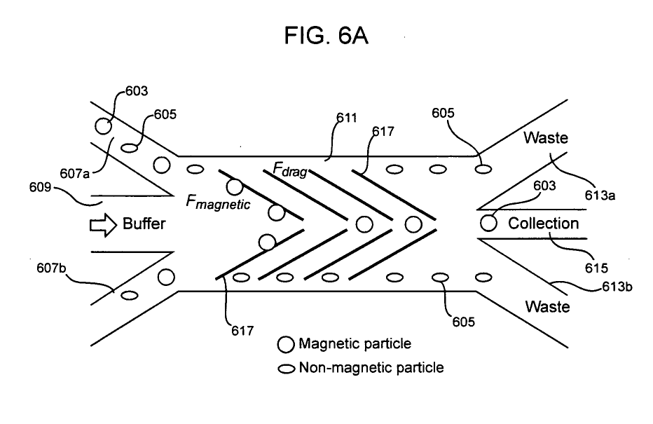

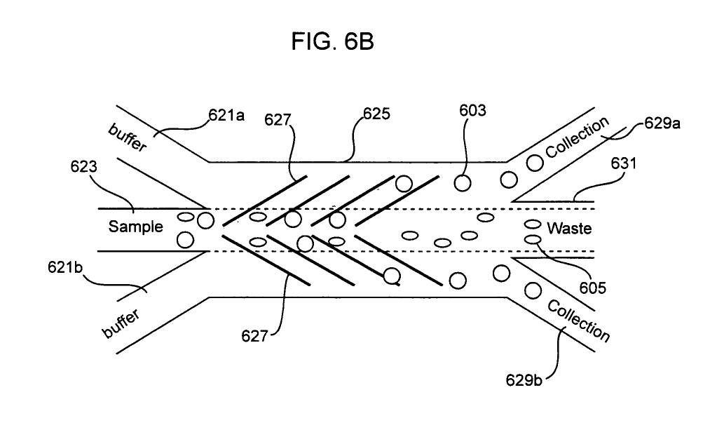

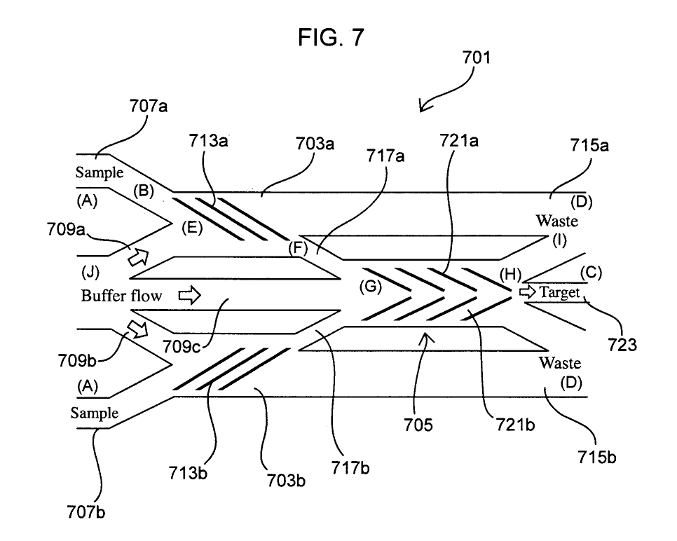

The pattern of material on or in the microfluidic substrate may take many different forms. In one embodiment it may take the form of a single strip or a collection of parallel strips. The example depicted in FIG. 6A shows four parallel strips comprising an MFG. Note that there are two MFGs in FIG. 6A, one for the magnetic particles entering the sorting region from sample channel 607a and the other for magnetic particles entering the region from sample channel 607b.

Examples of suitable dimensions for line-type MFG structures will now be presented. In certain embodiments employing ferromagnetic strips for use in sorting particles in a conventional buffer medium, the strips may be formed to a thickness of between about 1000 Angstroms and about 100 micrometers. The widths of such strips may be between about 1 micrometer and 1 millimeter; e.g., between about 5 and about 500 micrometers. The length, which depends on the channel dimensions and the angle of the strips with respect flow direction, may be between about 1 micrometer and 5 centimeters; e.g., between about 5 micrometers and about 1 centimeter. The spacing between individual strips in such design may be between about 1 micrometer and about 5 centimeters. The number of separate strips in the MFG may be between about 1 and 100. The angle of the strips with respect to the direction of flow may be between about −90° and +90°. For fractionation applications, it has been found that angles of between about 2° and 85° work well. Obviously, one or more dimensions of the MFG pattern may deviate from these ranges as appropriate for particular applications and overall design features.

In certain embodiments, the pattern of ferromagnetic material may take the form of one or more pins or pegs in the flow channel or on the substrate beside the flow channel or embedded in the substrate adjacent the flow channel. FIGS. 5A to 5E present arrangements of elements for MFGs in accordance with certain embodiments of the invention. In each case, the elements are provided within or proximate a flow channel in a magnetophoretic sorting region.

FIGS. 5A and 5B present two arrangements (rectangular and offset) of pin-type MFG elements depicted with respect to a direction of flow. The heights and widths of these elements may be in the same ranges as presented for the strip MFG elements presented herein. For comparison, FIGS. 5C-5E present arrangements of MFG elements taking forms of parallel linear strips (FIG. 5C), parallel curved strips (FIG. 5D), and chevrons (FIG. 5E).

The position and orientation of the permanent or other external magnet(s) with respect to a sorting region may be determined by the magnetic field strength produced by the permanent magnets, the homogeneity of the field (i.e., the uniformity of the field across the sorting region absent the MFG), the dimensions and shape of the magnet, etc. It generally desirable to have a uniform field produced by the external magnet(s) in the region of the MFG—assuming that the MFG is not present. In a typical case, two permanent magnets are employed, one located above the sorting region and the other located below the sorting region. In a specific embodiment, the magnets may be located above and below an MFG. In certain embodiments, two permanent magnets straddle a sorting region (i.e., the permanent magnets are located in the same plane as the sorting region or in a plane parallel to the plane of the sorting region). Certain embodiments employ a single magnet with one pole located above or below the sorting region. Still other embodiments employ generally U-shaped magnets in which poles at the terminal portions of the U straddle the sorting region (e.g., above and below or in the same plane).

(ii) Substrate

Substrates used in microfluidic systems are the supports in which the necessary elements for fluid transport are provided. The basic structure may be monolithic, laminated, or otherwise sectioned. Commonly, substrates include one or more microchannels serving as conduits for molecular libraries and reagents (if necessary). They may also include input ports, output ports, and/or features to assist in flow control.

In certain embodiments, the substrate choice may e dependent on the application and design of the device. Substrate materials are generally chosen for their compatibility with a variety of operating conditions. Limitations in microfabrication processes for a given material are also relevant considerations in choosing a suitable substrate. Useful substrate materials include, e.g., glass, polymers, silicon, metal, and ceramics.

Polymers are standard materials for microfluidic devices because they are amenable to both cost effective and high volume production. Polymers can be classified into three categories according to their molding behavior: thermoplastic polymers, elastomeric polymers and duroplastic polymers. Thermoplastic polymers can be molded into shapes above the glass transition temperature, and will retain these shapes after cooling below the glass transition temperature. Elastomeric polymers can be stretched upon application of an external force, but will go back to original state once the external force is removed. Elastomers do not melt before reaching their decomposition temperatures. Duroplastic polymers have to be cast into their final shape because they soften a little before the temperature reaches their decomposition temperature.

Among the polymers that may be used in microfabricated device of this invention are polyamide (PA), polybutylenterephthalate (PBT), polycarbonate (PC), polyethylene (PE), polymethylmethacrylate (PMMA), polyoxymethylene (POM), polypropylene (PP), polyphenylenether (PPE), polystyrene (PS) and polysulphone (PSU). The chemical and physical properties of polymers can limit their uses in microfluidics devices. Specifically in comparison to glass, the lower resistance against chemicals, the aging, the mechanical stability, and the UV stability can limit the use of polymers for certain applications.

Glass, which may also be used as the substrate material, has specific advantages under certain operating conditions. Since glass is chemically inert to most liquids and gases, it is particularly appropriate for applications employing certain solvents that have a tendency to dissolve plastics. Additionally, its transparent properties make glass particularly useful for optical or UV detection.

(iii) Surface Treatments and Coatings

Surface modification may be useful for controlling the functional mechanics (e.g., flow control) of a microfluidic device. For example, it may be advantageous to keep fluidic species from adsorbing to channel walls or for attaching antibodies to the surface for detection of biological components (e.g., library members on diverted magnetic beads).

Polymer devices in particular tend to be hydrophobic, and thus loading of the channels may be difficult. The hydrophobic nature of polymer surfaces also make it difficult to control electroosmotic flow (EOF). One technique for coating polymer surface is the application of polyelectrolyte multilayers (PEM) to channel surfaces. PEM involves filling the channel successively with alternating solutions of positive and negative polyelectrolytes allowing for multilayers to form electrostatic bonds. Although the layers typically do not bond to the channel surfaces, they may completely cover the channels even after long-term storage. Another technique for applying a hydrophilic layer on polymer surfaces involves the UV grafting of polymers to the surface of the channels. First grafting sites, radicals, are created at the surface by exposing the surface to UV irradiation while simultaneously exposing the device to a monomer solution. The monomers react to form a polymer covalently bonded at the reaction site.

Glass channels generally have high levels of surface charge, thereby causing proteins to adsorb and possibly hindering separation processes. In some situations, it may be advantageous to apply a polydimethylsiloxane (PDMS) and/or surfactant coating to the glass channels. Other polymers that may be employed to retard surface adsorption include polyacrylamide, glycol groups, polysiloxanes, glyceroglycidoxypropyl, poly(ethyleneglycol) and hydroxyethylated poly(ethyleneimine). Furthermore, for electroosmotic devices it is advantageous to have a coating bearing a charge that is adjustable in magnitude by manipulating conditions inside of the device (e.g. pH). The direction of the flow can also be selected based on the coating since the coating can either be positively or negatively charged.

Specialized coatings can also be applied to immobilize certain species on the channel surface—this process is known by those skilled in the art as “functionalizing the surface.” For example, a polymethylmethacrylate (PMMA) surface may be coated with amines to facilitate attachment of a variety of functional groups or targets. Alternatively, PMMA surfaces can be rendered hydrophilic through an oxygen plasma treatment process.

(iv) Microfluidic Elements

Microfluidic systems can contain a number of microchannels, valves, pumps, reactors, mixers and other components. Some of these components and their general structures and dimensions are discussed below.

Various types of valves can be used for flow control in microfluidic devices of this invention. These include, but are not limited to passive valves and check valves (membrane, flap, bivalvular, leakage, etc.). Flow rate through these valves are dependant on various physical features of the valve such as surface area, size of flow channel, valve material, etc. Valves also have associated operational and manufacturing advantages/disadvantages that should be taken into consideration during design of a microfluidic device.

Micropumps as with other microfluidic components are subjected to manufacturing constraints. Typical considerations in pump design include treatment of bubbles, clogs, and durability. Micropumps currently available include, but are not limited to electric equivalent pumps, fixed-stroke microdisplacement, peristaltic micromembrane and pumps with integrated check valves.

Macrodevices rely on turbulent forces such as shaking and stirring to mix reagents. In comparison, such turbulent forces are not practically attainable in microdevices, mixing in microfluidic devices is generally accomplished through diffusion. Since mixing through diffusion can be slow and inefficient, microstructures are often designed to enhance the mixing process. These structures manipulate fluids in a way that increases interfacial surface area between the fluid regions, thereby speeding up diffusion. In certain embodiments, microfluidic mixers are employed to mix magnetic beads and library members. Such mixers may be provide upstream from (and in some cases integrated with) a microfluidic separation device of this invention.

Micromixers may be classified into two general categories: active mixers and passive mixers. Active mixers work by exerting active control over flow regions (e.g.

varying pressure gradients, electric charges, etc.). Passive mixers do not require inputted energy and use only “fluid dynamics” (e.g. pressure) to drive fluid flow at a constant rate. One example of a passive mixer involves stacking two flow streams on top of one another separated by a plate. The flow streams are contacted with each other once the separation plate is removed. The stacking of the two liquids increases contact area and decreases diffusion length, thereby enhancing the diffusion process.

Mixing and reaction devices can be connected to heat transfer systems if heat management is needed. As with macro-heat exchangers, micro-heat exchanges can either have cocurrent, counter-current, or cross-flow flow schemes.

Microfluidic devices frequently have channel widths and depths between about 10 μm and about 10 cm. A common channel structure includes a long main separation channel, and three shorter “offshoot” side channels terminating in either a buffer, sample, or waste reservoir. The separation channel can be several centimeters long, and the three side channels usually are only a few millimeters in length. Of course, the actual length, cross-sectional area, shape, and branch design of a microfluidic device depends on the application as well other design considerations such as throughput (which depends on flow resistance), velocity profile, residence time, etc.

One example of a microfluidic device suitable for screening molecular libraries is depicted in FIG. 6A. As shown in the figure, a pattern of microfluidic channels is employed to separate magnetic particles 603 from non-magnetic particles 605. The microfluidic channels include sample inlet channels 607a and 607b, a buffer inlet channel 609, a sorting region 611, waste outlet channels 613a and 613b, and a collection channel 615. Within sorting region 611 multiple magnetic field gradient generator elements 617 are provided. In one embodiment, these are nickel strips provided within a flow channel of the sorting region itself. Not shown are one or more magnets that provide an external magnetic field in the sorting region. In one embodiment, a pair of permanent magnets is placed on the top and bottom of the sorting region. In other embodiments, one or more electromagnets may be employed to allow precise control of the field shape and homogeneity. The MFG strips interact with the field produced by the external magnet(s) to precisely shape and direct the magnetic field gradient within sorting region 611.

During operation, a buffer solution is introduced through buffer inlet channel 609 and a sample solution is introduced through sample inlet channels 607a and 607b. The sample solution may include magnetic particles and non-magnetic components from a library being analyzed (e.g., whole cells, cell components, macromolecules, non-biological particles, etc.). Typically, the buffer contains no library members. However, in some embodiments, the buffer may include reagents for facilitating other operations (non-sorting operations) performed in an integrated microfluidics system (e.g., sample amplification or detection). The buffer and sample solution flow through the sorting region in the laminar regime. Effectively, they flow through the sorting region as uniaxial streams, with little or no mixing. The little mixing that does occur is primarily diffusion driven.

The magnetic and non-magnetic particles entering sorting region 611 through sample inlet channels 607a and 607b experience a strong magnetic field gradient imposed by the magnet and MFG strips 617. The gradient has no effect on non-magnetic materials, so the force on non-magnetic components 605 is primarily in the direction of the F arrow in FIG. 6A. This is due to the uniaxial flow of the sample solution along the outer edges of sorting region 611. Magnetic particles 603, however, experience an effective force that is a vector sum of F_{drag} and F_{magnetic}, which is the force exerted on them by the magnetic field gradient as they pass over MFG elements in the sorting region. As can be seen in the figure, the resulting force vector “guides” magnetic particles 603 along the magnetic strips and across a laminar stream boundary into the buffer stream (i.e., toward the center of sorting region 611). This process is sometimes referred to as “buffer switching.” As a consequence of buffer switching, magnetic particles 603 are directed toward collection channel 615 in a buffer stream, while non-magnetic components 605 are directed toward waste outlet channels 613a and 613b. The output of collection channel 615 contains a significantly enriched composition of the target library members, as carried by the magnetic particles. As indicated, the magnetic particles are typically coated with a capture moiety.

A different embodiment is shown in FIG. 6B. As shown in this figure, the locations of the library and buffer streams are reversed such that library (including magnetic particles 603 and non-magnetic particles 605) flows in a central stream of the sorting device and buffer flows in two outer streams straddling the library stream. In this example, the MFGs again comprise a series of strips at the interfaces of the sample and buffer streams. However, the strips in this example are angled in the opposite direction (compared with the stripes in the embodiment of FIG. 6A) to thereby guide the magnetic particles out of the sample stream and into the peripheral buffer streams. In certain embodiments, the strips are configured so as to impart little if any influence on bulk fluid flow through the sorting region.

As shown in FIG. 6B, buffer enters the sorting station via inlet channels 621a and 621b. A library sample enters via a central inlet channel 623 and flows as a stream along side the buffer streams in a sorting region 625. There, the library stream encounters magnetic strips 627 which guide the magnetic particles 603 outward and into the buffer streams. The magnetic particles in the buffer streams exit collection channels 629a and 629b. Waste, including non-magnetic particles, exits a waste channel 631. This approach can provide an advantage of providing a library stream that need not change direction upon entry into the sorting region. As a consequence, it is unlikely that cells or other analyte component will become attached the channel walls.

As can be seen from the relative dimensions of the inlet and outlet channels of the sorting stations of FIGS. 6A and 6B, some of the buffer streams “bleedout” and flow out the waste channel. This reduces the likelihood that components from the sample stream will pass through the collection channel. As a result, the high purity of target library members in the collection stream will not be compromised.

Many other buffer switching schemes may be employed. See e.g., the discussion of flow systems and hydrodynamics in U.S. patent application Ser. No. 11/583,989, filed Oct. 18, 2006 and titled “MICROFLUIDIC MAGNETOPHORETIC DEVICE AND METHODS FOR USING THE SAME,” previously incorporated by reference. Some schemes employ multistage separations, multi-layer separations, etc.

Various computational tools are available for modeling the fluid flow and magnetic field gradients to ensure that the hydrodynamics and field gradient of a given design meet the necessary performance criteria. Examples of such tools include PSpice from Cadence Design Systems, San Jose, Calif., FemLab from Consol Ltd., Los Angeles, Calif., and Mathematica from Wolfram Research, Champaign, Ill.

Two or more sorting stages may be integrated on a single microfluidic system or even a single microfluidics chip in a sequential manner to improve purity. Further, in certain embodiments, at least two sorting stations are provided in parallel to improve throughput. In certain embodiments, at least three sorting stations are provided in parallel, and in certain embodiments at least four sorting stations are provided in parallel. Likewise, in certain embodiments, at least two, three, or four sorting stations (or stages) are provided in series. Frequently, when multiple stages are provided in series at least two of the upstream stations are provided in parallel. Their outputs may combine to feed a downstream station.

FIG. 7 presents one example of a microfluidics device 701 having three MFG-based sorting stations: two parallel stations 703a and 703b being provided upstream of a third station 705 fed by both the parallel upstream stages. The hydrodynamics of the multi-stage device is designed such that an inlet mixture of the sample is partitioned equally into the upper'and lower inlet sorting channels 707a and 707b of the first stage, while the buffer solution is divided into three streams provided by channels 709a, 709b, and 709c. In the first stage, all library members flow through sorting stations 703a and 703b having MFGs 713a and 713b (location E), and flow pattern is designed such that, when the MFGs are not magnetized by an external field, all library members transported to waste outlet channels 715a and 715b (location D). When the MFGs are magnetized by an external field, the magnetically-labeled library members are selectively deflected into the buffer stream via channels 717a and 717b. The selected members from the first stage (location G) are then passed through the second sorting stage (station 705) having MFGs 721a and 721b, thereby further purging non-selected library members to provide a relatively high purity solution of target to a collection channel 723 (location C).

In certain embodiments, magnetophoretic microfluidic devices permit fractionation of library members. Fractionating libraries of cells, for example, based on their differences in surface protein expression level allows quantitative and/or qualitative characterization of cells based on surface protein expression level. Fractionation may be used more generally to sort any sample based on degree of magnetization of various library components. The central concept is that sorting does not have to be a “binary” undertaking. Rather, it can be a ternary or higher degree separation process.

Fractionating using magnetophoretic techniques can be understood in terms of the following cell-based example. The resultant magnetic force \vec{F}_{M} on a cell depends on the expression level of target cells. This is because cells with more target expressed generally have greater numbers of magnetic particles coupled to them. The direction of the cells in flow is determined by a combination of the resultant magnetic force and the hydrodynamic viscous drag \vec{F}_{VD}. Using the design of an MFG, one can determine the deflection and average flow path of cells having differing levels of target expression. This allows the device design to precisely fractionate the cells by delivering different cells to multiple outlets, each offset from one another along a direction of deflection due to the magnetic field gradient.

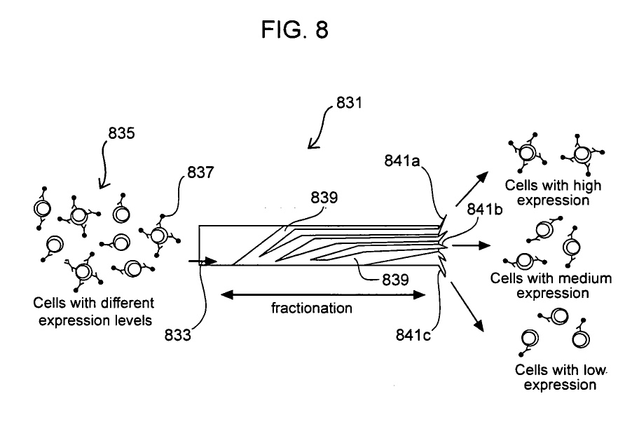

A fractionating sorting station will employ one or more MFGs to generate the magnetic force, and multiple outlets to collect fractionated samples. FIG. 8A shows a fractionating sorting station 831. It includes, at the lower left side of the diagram, an inlet channel 833 for receiving magnetically tagged cells 835 with different levels of expression. The varying levels of expression are indicated by different numbers of coupled antibody-magnetic particle conjugates 837. Sorting station 831 includes multiple strip-type MFGs 839, each having a different angle with respect the direction of flow. In the depicted example, MFGs located upstream have steeper angles than MFGs located downstream. As shown, the MFGs possess a steady progression of decreasing angle in moving from the most upstream position to the most downstream position. A collection of parallel outlet channels 841 is positioned at the downstream side of fractionating sorting station 831. Cells deflected the most by the MFGs exit the “top” outlet channel 841a. Cells deflected the least exit the “bottom” outlet channel 841c, and cells deflected by an intermediate amount exit the “middle” outlet channel 841b. As can be seen in the figure, cells with a high level of expression can be collected from outlet channel 841a, cells with an intermediate level of expression can be collected from outlet channel 841b, and cells with a low level of expression can be collected from outlet channel 841c.

A prototype fractionating sorting station was produced in which the MFGs were fabricated by electron-beam evaporation of 0.2-μm nickel thin film on borosilicate glass wafers after lithography and a lift-off process. Microfluidic ports were drilled into the glass substrates using a computer-controlled milling machine. Microfluidic channels were fabricated on a silicon wafer using a deep reactive-ion-etcher, which produced 35 μm deep channels. Polydimethylsiloxane (PDMS) replicas of the silicon master mold were fabricated by applying a precursor to the silicon master, followed by curing at 70° C. for 3 hours.

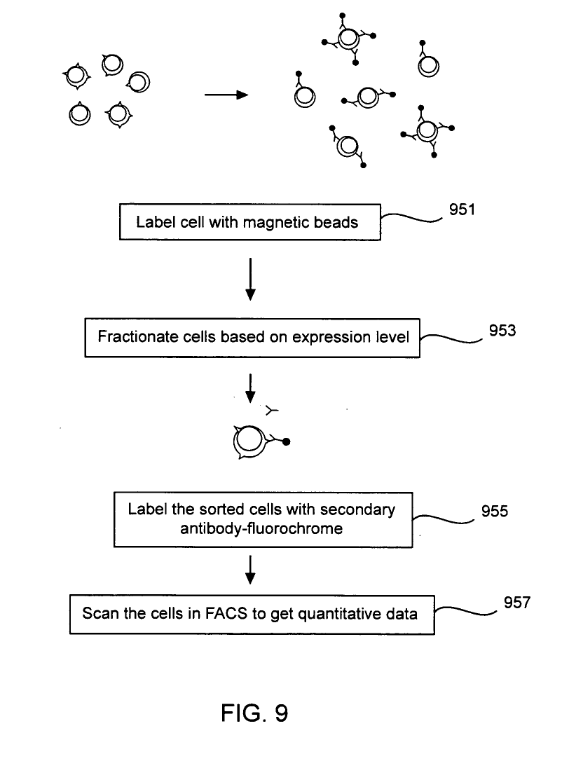

To fractionate cell by surface protein expression level, a sequence of steps may be performed as shown in FIG. 9. First, cells from a library are labeled with magnetic beads (block 951). Second, the labeled cells enter a fractionation sorting station where they are sorted/fractionated (block 953). Next, the sorted cells are labeled with a secondary antibody-fluorochrome conjugate (block 955). Finally, the cells are analyzed using flow cytometry for quantitative data (block 957). Using the sorting station, the cells are fractionated based on their expression level and collected at multiple outlets.

In another example, cells or other species of interest may have two or more different types of markers (e.g., two different surface proteins or an antigen having two discrete epitopes). A sample suspected of harboring such species is treated with multiple different types of magnetic particles, one having an affinity for a first marker and another having an affinity for a second marker. Species having no markers will not be labeled. Species having only one marker will be labeled, but with only one type of magnetic particle. Species having two markers will be labeled with two or more different types of magnetic particles. In a sorting station, the species having two more distinct markers will deflect to a greater degree than species having only one marker. Thus, a fractionating sorting station will be able to separately collect species with no markers, species with only marker, and species having multiple markers. Obviously, the idea can be extended to greater numbers of markers, three, four, etc.

As illustrated in FIG. 7, certain embodiments make use of a parallel branch architecture. In some embodiments, a three-dimensional “channel circuit” may be employed. The microchannel design is optimized to achieve a uniform flow pattern in each of multiple sorting stations. One challenge in implementing a three-dimensional channel circuit is the fact that flow streams may have to cross each other to achieve the necessary routing. To address this challenge, multiple layers for fluid distribution are used, analogous to an over-pass in a highway, where the buffer is introduced and divided into several sub streams in one layer, while the library sample is introduced and infused into several downstream channels in another layer. This way, only two microfluidic connections are required at the inlet.

One goal is to design the channel structure so that essentially the same flow pattern results in every single channel. With a relatively wide inflow channel, one can achieve the same flow velocity and distribution in each channel. Generally this means that the fluidic resistance in the branches should be significantly greater than of the trunk or parent branch, typically on the order of at least 10× greater and sometimes in the range of 100× greater.

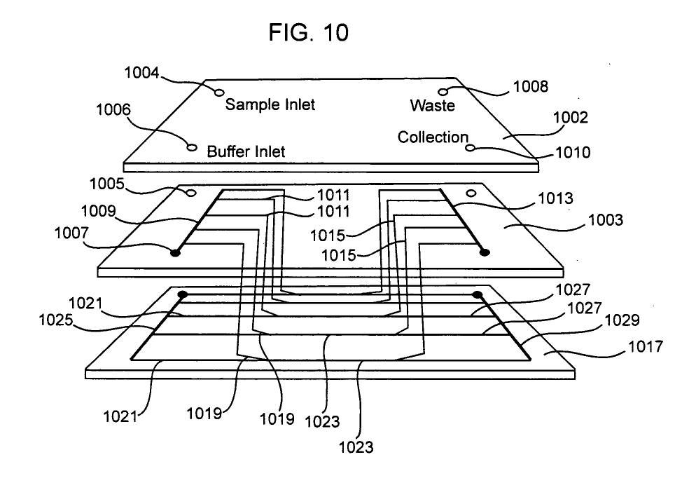

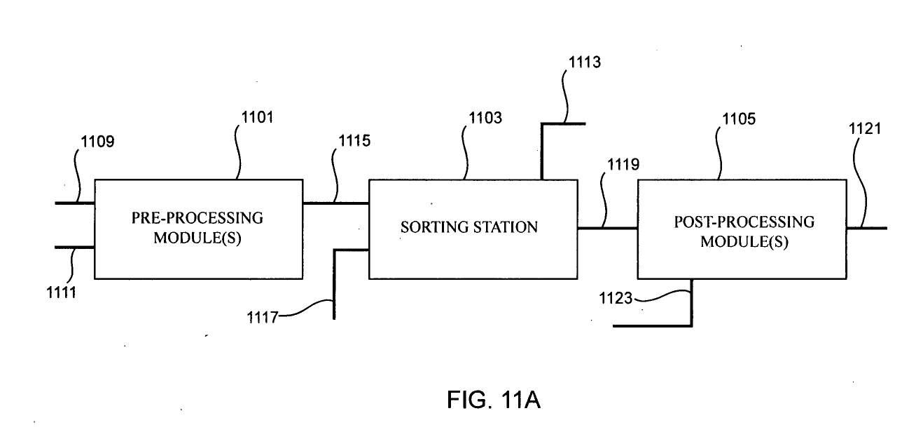

In an embodiment 1001 depicted in FIG. 10 (a schematic view), a top layer 1002 includes a port 1004 for sample inlet, a port 1006 for buffer inlet, a port 1008 for waste outlet, and a port 1010 for collection outlet. Underlying top layer 1002 is a layer 1003 that includes a sample inlet 1005, a buffer inlet 1007. Sample inlet 1005 allows sample to pass through layer 1003 to an underlying layer having features for distributing sample into multiple streams. Layer 1003 also includes a channel 1009 for distributing buffer into multi stream channels 1011 that direct the buffer to parallel sorting stations on a lower level. Layer 1003 further includes a channel for collecting the target collection from multiple collection stream channels 1015 from the sorting stations. A lower layer 1017 includes buffer inlets 1019 and multiple channels 1021 for distributing sample to multiple sorting stations 1023. The sample channels 1021 receive sample distributed from a main sample channel 1025, also located on lower layer 1017. The main sample channel provides a central connection with the sample inlet port 1004. Multiple waste outlet channels 1027 for receiving waste streams from the sorting stations are also provided on layer 1017. Finally, a main waste collection channel 1029 is provided on layer 1017 for providing a central contact with waste port 1008 on the top layer.

To analytically model this approach, the flow field of a device with five channels was modeled in FEMLAB 3.1 (Comsol). During the simulation the width of inflow channel and distance between each sorting station was optimized. The flow field was calculated with an incompressible Navier-Stokes equation and the fluid properties were set to be aqueous. The steady state velocity field in each sorting station was shown to be nearly identical.

(v) Fluid Manipulation

Various modes of fluid transport or actuation may be employed with the present invention. Within a microfluidic device, these modes may cause bulk movement of the fluid or focused movement of particular components in a fluid medium or movement of discrete fluid plugs. Driving forces for fluid movement include pressure or hydraulic forces, surface tension gradients, electrokinetic effects, magnetophoretic effects, capillary action, etc.

Pressure (e.g. hydrostatic head) is commonly used to effectuate fluid movement. Pressure movement has the advantage of being insensitive to chemical properties of the buffers or surface reactivity of the reagents. However, the fluid usually does not move with constant velocity across the channel. Various types of pumps or gravity feed devices may be employed to induce pressure movement.

Electrokinetic transport may also be employed to move fluids within a microfluidic device. Electrokinetic fluid manipulation processes involve the use of electro-osmosis and/or electrophoresis to transport fluids in microfluidic devices.

Electro-osmosis is mainly used to actuate bulk fluid movement while electrophoresis is used to drive the movement of individual chemical species (which can impact the bulk flow in a microfluidics device). In general, electrokinetic fluid movement is not particularly sensitive to channel dimensions, but is very sensitive to pH, ionic strength of a buffer medium, and the surface activity of the compounds being tested. Therefore the composition of the fluid medium in which the library is provided should complement the electrokinetic driving mechanism if such mechanism is employed.

Electrokinetic effects may also be employed to drive separation processes. While most embodiments of this invention employ magnetic fields to drive separation of library components, some implementations will make use of complimentary magnetophoretic and electrophoretic separation techniques. Further, electrokinetic approaches may be used in ancillary processes of this invention such as mixing and reacting reagents, injection or dispensing of samples, and downstream chemical separations. Examples of electrically driven separation techniques that may be used with this invention include capillary electrophoresis (CE), open channel electrochromatography (OCEC) and micellar electrokinetic capillary chromatography (MEKC).

Injection methods may be employed to insert discrete plugs of fluid into continuously flowing streams within microfluidic devices. Among the injection schemes that may be employed to provide controlled delivery of media containing library members are gated injection and cross injection. Gated injection involves the interaction of two solutions: a mobile phase and a sample solution at the intersection of several channels. The sample solution travels through one channel (“separation channel”) while the mobile phase solution travels through the intersecting channel(s). The flow through these channels can be regulated through, for example, an electrokinetic process. First, the voltage for the mobile phase solution is switched off, and the sample solution is injected into the separation channel. After a specific time, the voltage to the mobile phase reservoir is switched on, which defines the flow boundaries of the injection “plug.” Magnetophoretic separation may be controlled in a manner that applies specifically to the plug.

As mentioned, magnetophoretic effects may be employed alone or in combination with another effect such as an electrokinetic effect to drive separation of library components. One example of another separation mechanism that may be employed together with magnetophoresis is a diffusion barrier. Diffusion barriers are generally “microfilters” constructed of synthetic, ceramic, or metallic materials.

These microfilters typically separate according to particle size by filtering out larger particles. Pore sizes can range from about 0.1 to about 100 μm in diameter. The membrane ranges from about 0.5 to about 5 μm in thickness. There are also diffusion-based separation processes that do not use a microfilter. One example is the H-filter from Micronics. The H-filter is used to extract small particles from a solution also containing large particles. The horizontal section of the “H” allows diffusion to occur—the smaller particles diffuse faster and is then extract upwards while a solution containing both large and small particles flow downward.

Dielectrophoresis is another technique that may be employed together with magnetophoresis in particle separation. Dielectrophoresis involves the use of an alternating electric field to induce a dipole on a particle suspended in liquid. The electric field causes the dipole to move the particle in a desired direction.

(vi) Methods of Fabrication

Microfabrication processes differ depending on the type of materials used in the substrate and the desired production volume. For small volume production or prototypes, fabrication techniques include LIGA, powder blasting, laser ablation, mechanical machining, electrical discharge machining, photoforming, etc. Technologies for mass production of microfluidic devices may use either lithographic or master-based replication processes. Lithographic processes for fabricating substrates from silicon/glass include both wet and dry etching techniques commonly used in fabrication of semiconductor devices. Injection molding and hot embossing typically are used for mass production of plastic substrates.

a. Glass, Silicon and Other “Hard” Materials (Lithography, Etching, Deposition)

The combination of lithography, etching and deposition techniques may be used to make microcanals and microcavities out of glass, silicon and other “hard” materials. Technologies based on the above techniques are commonly applied in for fabrication of devices in the scale of 0.1-500 micrometers.

Microfabrication techniques based on current semiconductor fabrication processes are generally carried out in a clean room. The quality of the clean room is classified by the number of particles <4 μm in size in a cubic inch. Typical clean room classes for MEMS microfabrication are 1000 to 10000.

In certain embodiments, photolithography may be used in microfabrication. In photolithography, a photoresist that has been deposited on a substrate is exposed to a light source through an optical mask. Conventional photoresist methods allow structural heights of up to 10-40 μm. If higher structures are needed, thicker photoresists such as SU-8, or polyimide, which results in heights of up to 1 mm, can be used.

After transferring the pattern on the mask to the photoresist-covered substrate, the substrate is then etched using either a wet or dry process. In wet etching, the substrate—area not protected by the mask—is subjected to chemical attack in the liquid phase. The liquid reagent used in the etching process depends on whether the etching is isotropic or anisotropic. Isotropic etching generally uses an acid to form three-dimensional structures such as spherical cavities in glass or silicon. Anisotropic etching forms flat surfaces such as wells and canals using a highly basic solvent. Wet anisotropic etching on silicon creates an oblique channel profile.

Dry etching involves attacking the substrate by ions in either a gaseous or plasma phase. Dry etching techniques can be used to create rectangular channel cross-sections and arbitrary channel pathways. Various types of dry etching that may be employed including physical, chemical, physico-chemical (e.g., RIE), and physico-chemical with inhibitor. Physical etching uses ions accelerated through an electric field to bombard the substrate's surface to “etch” the structures. Chemical etching may employ an electric field to migrate chemical species to the substrate's surface. The chemical species then reacts with the substrate's surface to produce voids and a volatile species.

In certain embodiments, deposition is used in microfabrication. Deposition techniques can be used to create layers of metals, insulators, semiconductors, polymers, proteins and other organic substances. Most deposition techniques fall into one of two main categories: physical vapor deposition (PVD) and chemical vapor deposition (CVD). In one approach to PVD, a substrate target is contacted with a holding gas (which may be produced by evaporation for example). Certain species in the gas adsorb to the target's surface, forming a layer constituting the deposit. In another approach commonly used in the microelectronics fabrication industry, a target containing the material to be deposited is sputtered with using an argon ion beam or other appropriately energetic source. The sputtered material then deposits on the surface of the microfluidic device. In CVD, species in contact with the target react with the surface, forming components that are chemically bonded to the object. Other deposition techniques include: spin coating, plasma spraying, plasma polymerization, dip coating, casting and Langmuir-Blodgett film deposition. In plasma spraying, a fine powder containing particles of up to 100 μm in diameter is suspended in a carrier gas. The mixture containing the particles is accelerated through a plasma jet and heated. Molten particles splatter onto a substrate and freeze to form a dense coating. Plasma polymerization produces polymer films (e.g. PMMA) from plasma containing organic vapors.

Once the microchannels, microcavities and other features have been etched into the glass or silicon substrate, the etched features are usually sealed to ensure that the microfluidic device is “watertight.” When sealing, adhesion can be applied on all surfaces brought into contact with one another. The sealing process may involve fusion techniques such as those developed for bonding between glass-silicon, glass-glass, or silicon-silicon.

Anodic bonding can be used for bonding glass to silicon. A voltage is applied between the glass and silicon and the temperature of the system is elevated to induce the sealing of the surfaces. The electric field and elevated temperature induces the migration of sodium ions in the glass to the glass-silicon interface. The sodium ions in the glass-silicon interface are highly reactive with the silicon surface forming a solid chemical bond between the surfaces. The type of glass used should ideally have a thermal expansion coefficient near that of silicon (e.g. Pyrex Corning 7740).

Fusion bonding can be used for glass-glass or silicon-silicon sealing. The substrates are first forced and aligned together by applying a high contact force. Once in contact, atomic attraction forces (primarily van der Waals forces) hold the substrates together so they can be placed into a furnace and annealed at high temperatures. Depending on the material, temperatures used ranges between about 600 and 1100° C.

b. Polymers/Plastics

A number of techniques may be employed for micromachining plastic substrates in accordance with embodiments of this invention. Among these are laser ablation, stereolithography, oxygen plasma etching, particle jet ablation, and microelectro-erosion. Some of these techniques can be used to shape other materials (glass, silicon, ceramics, etc.) as well.

To produce multiple copies of a microfluidic device, replication techniques are employed. Such techniques involve first fabricating a master or mold insert containing the pattern to be replicated. The master is then used to mass-produce polymer substrates through polymer replication processes.

In the replication process, the master pattern contained in a mold is replicated onto the polymer structure. In certain embodiments, a polymer and curing agent mix is poured onto a mold under high temperatures. After cooling the mix, the polymer contains the pattern of the mold, and is then removed from the mold. Alternatively, the plastic can be injected into a structure containing a mold insert. In microinjection, plastic heated to a liquid state is injected into a mold. After separation and cooling, the plastic retains the mold's shape.

PDMS (polydimethylsiloxane), a silicon-based organic polymer, may be employed in the molding process to form microfluidic structures. Because of its elastic character, PDMS is well suited for microchannels between about 5 and 500 μm. Specific properties of PDMS make it particularly suitable for microfluidic purposes:

1) It is optically clear which allows for visualization of the flows;

2) PDMS when mixed with a proper amount of reticulating agent has elastomeric qualities that facilitates keeping microfluidic connections “watertight;”

3) Valves and pumps using membranes can be made with PDMS because of its elasticity;

4) Untreated PDMS is hydrophobic, and becomes temporarily hydrophilic after oxidation of surface by oxygen plasma or after immersion in strong base; oxidized PDMS adheres by itself to glass, silicon, or polyethylene, as long as those surfaces were themselves exposed to an oxygen plasma.

5) PDMS is permeable to gas. Filling of the channel with liquids is facilitated even when there are air bubbles in the canal because the air bubbles are forced out of the material. But it's also permeable to non polar-organic solvents.

Microinjection can be used to form plastic substrates employed in a wide range of microfluidic designs. In this process, a liquid plastic material is first injected into a mold under vacuum and pressure, at a temperature greater than the glass transition temperature of the plastic. The plastic is then cooled below the glass transition temperature. After removing the mold, the resulting plastic structure is the negative of the mold's pattern.

Yet another replicating technique is hot embossing, in which a polymer substrate and a master are heated above the polymer's glass transition temperature, T_{g} (which for PMMA or PC is around 100-180° C.). The embossing master is then pressed against the substrate with a preset compression force. The system is then cooled below T_{g} and the mold and substrate are then separated.

Typically, the polymer is subjected to the highest physical forces upon separation from the mold tool, particularly when the microstructure contains high aspect ratios and vertical walls. To avoid damage to the polymer microstructure, material properties of the substrate and the mold tool have to be taken into consideration. These properties include: sidewall roughness, sidewall angles, chemical interface between embossing master and substrate and temperature coefficients. High sidewall roughness of the embossing tool can damage the polymer microstructure since roughness contributes to frictional forces between the tool and the structure during the separation process. The microstructure is destroyed if frictional forces are larger than the local tensile strength of the polymer. Friction between the tool and the substrate are critical in microstructures with vertical walls. The chemical interface between the master and substrate could also be of concern. Because the embossing process subjects the system to elevated temperatures, chemical bonds could form in the master-substrate interface. These interfacial bonds could interfere with the separation process. Differences in the thermal expansion coefficients of the tool and the substrate could create addition frictional forces.

Various techniques can be employed to form molds, embossing masters, and other masters containing patterns used to replicate plastic structures through the replication processes mentioned above. Examples of such techniques include LIGA (described below), ablation techniques, and various other mechanical machining techniques. Similar techniques can also be used for creating masks, prototypes and microfluidic structures in small volumes. Materials used for the mold tool include metals, metal alloys, silicon and other hard materials.

Laser ablation may be employed to form microstructures either directly on the substrate or through the use of a mask. This technique uses a precision-guided laser, typically with wavelength between infrared and ultraviolet. Laser ablation may be performed on glass and metal substrates, as well as on polymer substrates. Laser ablation can be performed either through moving the substrate surface relative to a fixed laser beam, or moving the beam relative to a fixed substrate. Various micro-wells, canals, and high aspect structures can be made with laser ablation.

Certain materials such as stainless steel make very durable mold inserts and can be micromachined to form structures down to the 10-μm range. Various other micromachining techniques for microfabrication exist including μ-Electro Discharge Machining (μ-EDM), μ-milling, focused ion beam milling. μ-EDM allows the fabrication of 3-dimensional structures in conducting materials. In μ-EDM, material is removed by high-frequency electric discharge generated between an electrode (cathode tool) and a workpiece (anode). Both the workpiece and the tool are submerged in a dielectric fluid. This technique produces a comparatively rougher surface but offers flexibility in terms of materials and geometries.

Electroplating may be employed for making a replication mold tool/master out of, e.g., a nickel alloy. The process starts with a photolithography step where a photoresist is used to defined structures for electroplating. Areas to be electroplated are free of resist. For structures with high aspect ratios and low roughness requirements, LIGA can be used to produce electroplating forms. LIGA is a German acronym for Lithographic (Lithography), Galvanoformung (electroplating), Abformung (molding). In one approach to LIGA, thick PMMA layers are exposed to x-rays from a synchrotron source. Surfaces created by LIGA have low roughness (around 10 nm RMS) and the resulting nickel tool has good surface chemistry for most polymers.

As with glass and silicon devices, polymeric microfluidic devices must be closed up before they can become functional. Common problems in the bonding process for microfluidic devices include the blocking of channels and changes in the physical parameters of the channels. Lamination is one method used to seal plastic microfluidic devices. In one lamination process, a PET foil (about 30 μm) coated with a melting adhesive layer (typically 5-10 μm) is rolled with a heated roller, onto the microstructure. Through this process, the lid foil is sealed onto the channel plate. Several research groups have reported a bonding by polymerization at interfaces, whereby the structures are heated and force is applied on opposite sides to close the channel. But excessive force applied may damage the microstructures. Both reversible and irreversible bonding techniques exist for plastic-plastic and plastic-glass interfaces. One method of reversible sealing involves first thoroughly rinsing a PDMS substrate and a glass plate (or a second piece of PDMS) with methanol and bringing the surfaces into contact with one another prior to drying. The microstructure is then dried in an oven at 65° C. for 10 min. No clean room is required for this process. Irreversible sealing is accomplished by first thoroughly rinsing the pieces with methanol and then drying them separately with a nitrogen stream. The two pieces are then placed in an air plasma cleaner and oxidized at high power for about 45 seconds. The substrates are then brought into contact with each other and an irreversible seal forms spontaneously.

Other available techniques include laser and ultrasonic welding. In laser welding, polymers are joined together through laser-generated heat. This method has been used in the fabrication of micropumps. Ultrasonic welding is another bonding technique that may be employed in some applications.

Integrated Microfluidic Systems

In some embodiments, library screening applications of this invention can be generally divided into a pre-processing phase, a magnetophoretic sorting phase, and a post-processing phases. Each of these phases may constitute one or more sub-phases. For example, as indicated in the discussion above a sorting device may include multiple magnetophoretic stages. In some embodiments, all or some of the pre- and post-processing operations may be performed on an integrated device or system that also includes the magnetophoretic sorting station(s).

On the pre-processing side, a library sample may be treated to remove particulate matter, viscous material, insoluble material, and the like. Optionally, library sample components that bind non-specifically with the magnetic particles are removed in a sample pretreatment operation in which the sample is contacted with a pool of magnetic particles. This optional process may be appropriate when, for example, the magnetic particles are incubated such that some library members are reasonably likely to bind. After the magnetic particles and sample are incubated for an appropriate period of time, the particles may be removed from the sample by, e.g., a negative magnetophoretic operation.

In another optional pre-processing operation, the target library members in the sample are labeled with magnetic particles. Typically, this simply involves contacting the sample with magnetic particles that have been coated with an antibody or other capture moiety specific for the target, where the antibody or other capture agent has suitable binding affinity and specificity for the target species. In certain embodiments, the antibody or other capture moiety has an affinity for its target species of at least about 10⁻⁴ M, such as at least about 10⁻⁶ M and including at least about 10⁻⁸ M, where in certain embodiments the antibody or other capture moiety has an affinity for its target species of between about 10⁻⁹ and 10⁻¹² M. In certain embodiments, the antibody or other capture moiety is specific for the target species, in that it does not significantly bind or substantially affect non-target species that may be present in the library. In some cases, the sample and magnetic particles may be contacted with a bifunctional reagent having one moiety that binds with a target species and another moiety that binds with the surface of magnetic particles. If the magnetic particles are coated with streptavidin for example, a suitable bifunctional reagent may be a biotinylated antibody specific for the target in the sample. Alternatively, one could directly modify surface of magnetic particles to immobilize entity having specific feature for binding with species of interest.

In another optional pre-processing example, the sample is optionally filtered or otherwise treated to remove debris that might clog device channels or otherwise interfere with the process. Examples of material that may be filtered from a sample includes coagulated sample materials, precipitates, etc.

Various post-processing operations are contemplated; a few will be described here. One of these involves lysing collected target cells. In some embodiments, lysis is conducted while cells are held stationary. This operation may be appropriate for analysis of pathogens such as bacteria for example. In some examples, the lysed pathogen provides components such as genetic material, particular organelles, or other characteristic biological or chemical components for detection. Another post-processing operation amplifies the contents of the lysed target to produce an increased signal of a target sequence of interest. Amplification is primarily relevant when particular genetic material is to be analyzed or detected. PCR or other known amplification techniques may be appropriate for this purpose.

Another post-processing operation may involve detection; e.g., detecting the presence of the target via a microscopy, a fluorescent signature, a radioactive signal, etc. Examples of detection processes suitable for use with the invention include continuous flow processes such as various cell counting techniques or immobilization techniques such as microarray analysis.

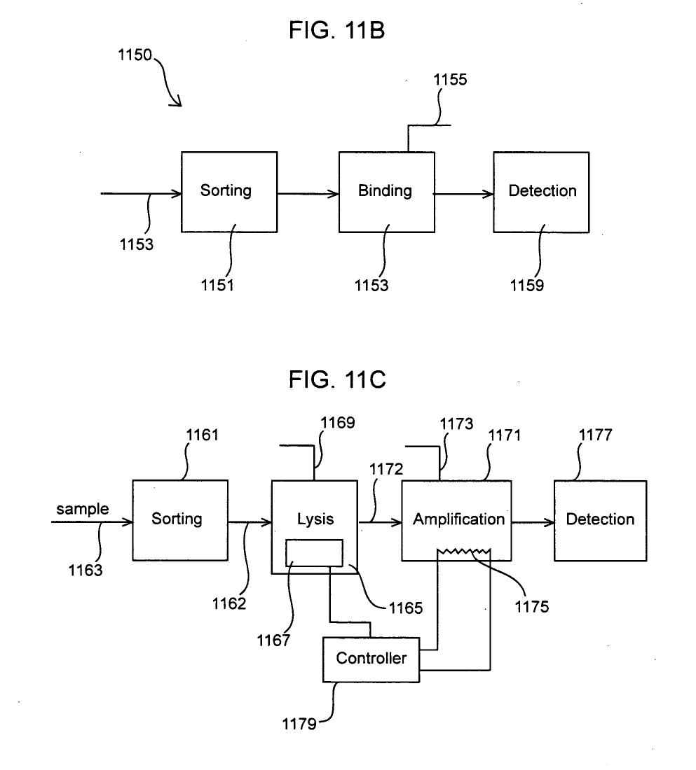

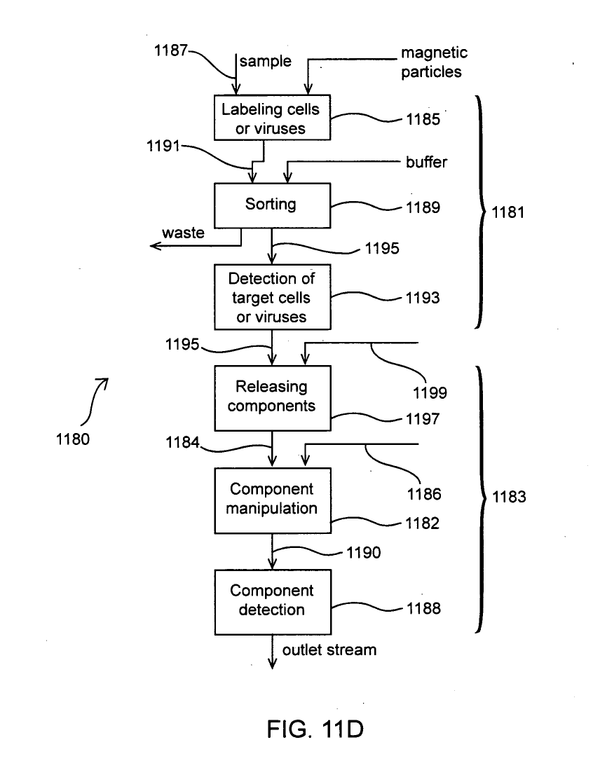

As indicated, various pre- and post-processing operational modules may be integrated in a microfluidics system, and in some cases on a single microfluidics chip. FIG. 11A depicts a generic microfluidics system having modules located upstream and/or downstream from the sorting station. The embodiment of FIG. 11A includes at least three general subsystems: a pre-processing subsystem 1101, a sorting subsystem 1103, and a post-processing subsystem 1105.

In the depicted embodiment, the pre-processing subsystem 1101 includes a first inlet channel 1109 for receiving the library sample and one or more additional inlet channels (represented by second inlet channel 1111). Depending on the design and application, these additional channels may be used to introduce magnetic particles, diluents, additives for tailoring rheological properties, etc. Pre-processing module 1101 also includes an outlet channel 1115 for providing labeled sample to the sorting subsystem 1103. The pre-processing module 1101 may optionally include one or more other outlets (not shown). As an example, the pre-processing subsystem may include modules or stations for filtering the sample, concentrating or diluting a sample, providing additives to adjust rheological properties of the sample, labeling the sample with the magnetic particles, disrupting sample components (e.g., lysis, viral protein coat disruption, etc.), and the like.

Typically, though not necessarily, sorting subsystem 1103 will include one or more MFG-based sorting stations including at least a buffer inlet channel 1117, a sample inlet channel 1115, a waste outlet channel 1113, and a collection channel 1119 as described above. If a fractionation sorting module is employed, there will be multiple collection channels.

The post-processing subsystem 1105 receives magnetically labeled target components via the collection channel 1119. It expels processed fluids via an outlet channel 1121. Subsystem 1105 also optionally includes one or more inlets 1123 for providing fluids necessary for effecting one or more post-processing operations (e.g., chemical lysing reagent or primers, nucleotides, polymerase, etc. for PCR). The post-processing subsystem may include modules for direct detection of the target via an appropriate detection technique, and it may optionally include additional pre-detection modules such as a lysis module or and amplification module as described herein. A detection module and any additional module may be implemented in one or more stations.

A controller is commonly employed to control the operations of an integrated microfluidics system. Algorithms implemented on a controller control the sequence and timing of flow to various modules through various ports, temperature cycling, application of magnetic and/or electric fields, and optical excitation and detection schemes, for example. While the controller is not shown or described extensively herein, one of skill in the art will understand that controllers may be employed with sorting modules and larger integrated systems herein. Controllers interpret signals from various sensors (if present) associated with the microfluidics device and provide instructions for controlling operations on the microfluidics system. All this is accomplished under the control of hardware and/or software logic, which may be implemented on a dedicated, specially designed microprocessor system or a specially configured general purpose computing system.

A few specific examples of integrated microfluidic systems will now be presented. In FIG. 11B, an integrated microfluidic system 1150 is useful for identifying cells or other library members having at least two accessible target proteins. In this embodiment, a library sample is provided to a sorting station 1151 along with magnetic beads coated with an antibody to a first target on library members to be selected. The beads may be provided via an inlet channel 1153. A separate buffer inlet may also be provided. After sorting the magnetically labeled tumor cells, they flow to a binding station 1153 where fluorescently labeled antibodies to a second target on the library members to be selected are delivered via an inlet channel 1155. There, the antibodies come in contact with and bind to surface antigens on the library members. The cells then flow to a detection module 1159, where they are exposed to light of an excitation frequency for the fluorophore of the second antibody. Fluorescence detected on trapped cells indicates that the cells harbor both the first and second targets.

In FIG. 11C, a library of bacteria is introduced to a sorting station 1161 via an inlet channel 1163. In this example, it is assumed that the sample has been pre-labeled with magnetic beads coated with an antibody to a surface protein of the target bacterium. Such labeling may be accomplished off-chip or on-chip in a pre-processing module or station as indicated above. Sorting in station 1161 separates the bacteria in question from other sample components. In the depicted embodiment, the magnetic beads (with attached bacteria if present) are delivered via a collection channel 1162 to a lysis station 1165 where a strong magnetic field is temporarily applied via a magnet 1167 (permanent or electromagnet) to hold the magnetic beads stationary. Then a chemical lysing agent is introduced to lysing station 1165 via an inlet 1169. The lysing agent disrupts the bacterial membranes to release the genetic material, which is then free to pass out of the lysis chamber in a flow field to an amplification module 1171 through a channel 1172. In this module, nucleotide building blocks, primers, Taq polymerase, fluorescent monitoring probes, buffer, etc.

are provided via an inlet channel 1173. Thermal cycling to drive a polymerase chain reaction in module 1171 is controlled using a heating element 1175. The bacterial DNA is thereby amplified while passing through module 1171. It then passes out of the amplification module and enters a detection module 1177 (e.g., a microarray), where it may be detected via a fluorescent signature. Alternatively, PCR may be conducted using a fluorescent oligonucleotide probe to enable fluorescent detection in detection module 1177. Note that a controller 1179 may be employed to control the timing of thermal cycling, the application of a magnetic field, etc. during operation.

Certain embodiments employ two levels of selection/detection, one for a first target species located on the surface of a cell or virus in a library and a second for a second target associated with a component of the cell or virus. One example of an integrated device or system that may be employed for this purpose is depicted in FIG. 11D. In the depicted example, a first section of the device/system labels, separates and detects target cells or viruses from a library. A second section then releases components of selected cells or virus, which components are further manipulated by, e.g., amplification, and ultimately detected. Hence whole cells or viruses are first isolated or detected and then one or more components of the cells or viruses are separately detected. In some embodiments, the first target on the cell or virus is a surface protein, saccharide, or lipid. In some embodiments, the second target of the cell or virus is a nucleic acid or intracellular protein, saccharide, or lipid.

Turning now to FIG. 11D, a device or system 1180 includes a first detection section 1181 for detecting a cell or virus and a second detection section 1183 for detecting a cell or virus component. Sections 1181 and 1183 are in fluid communication with one another. In detection section 1181, a library is provided a labeling station 1185 via a sample inlet 1187. In this station, the library members are contacted with magnetic particles which label cells or viruses having a first target on their membranes or protein coats. Labeled cells or viruses then flow to a sorting station 1189 via an inlet 1191. In station 1189, buffer switching takes place under the influence of a magnetic field gradient in the manner described above. Cells or viruses harboring a surface target are thereby separated from other components of the sample and selectively delivered to a first detection station 1193 via a channel 1195. The cells or viruses are detected using fluorescence or other signature.

At this point in the device of system, the first level of detection has been completed and the cells or viruses are ready for the second level of detection, which is implemented in section 1183. Initially, cells or viruses leave detection station 1193 and flow via a channel 1195 to a station 1197 where the cells or viruses are disrupted in a manner that releases at least some of their components for further analysis. As explained elsewhere, the necessary disruption may be chemical, thermal, mechanical, acoustic, etc. as appropriate for the species of sample under analysis. In the depicted example, a separate inlet channel 1199 provides reagent for disrupting the cell membrane or viral protein coat to release genetic material or other contents. In some embodiments, the cells or viruses are held stationary (at least temporarily) during treatment to release their components. The components released from the cell or membrane travel via a channel 1184 from station 1197 to a station 1182, where the components are “manipulated” to facilitate further detection. The type of manipulation employed depends upon the type of component under consideration. For example, nucleic acids may be amplified in station 1182 as described elsewhere herein. In other examples, subcellular components such as Golgi, cytoskeletal components, histones, mitochondria, etc. may be labeled with markers specific for those components (typically a biomolecule found within the component) in station 1182. The markers, amplification reagents, or other component manipulation agent may flow into station 1182 via an inlet channel 1186. After appropriate manipulation in station 1182, the components flow to a component detection station via a channel 1190. There the component itself is detected by fluorescence, etc. as understood by those of skill in the art.

The nucleic acid amplification technique described here is a polymerase chain reaction (PCR). However, in certain embodiments, non-PCR amplification techniques may be employed such as various isothermal nucleic acid amplification techniques; e.g., real-time strand displacement amplification (SDA), rolling-circle amplification (RCA) and multiple-displacement amplification (MDA).

Regarding PCR amplification modules, it will be necessary to provide to such modules at least the building blocks for amplifying nucleic acids (e.g., ample concentrations of four nucleotides), primers, polymerase (e.g., Taq), and appropriate temperature control programs). The polymerase and nucleotide building blocks may be provided in a buffer solution provided via an external port to the amplification module or from an upstream source. In certain embodiments, the buffer stream provided to the sorting module contains some of all the raw materials for nucleic acid amplification. For PCR in particular, precise temperature control of the reacting mixture is extremely important in order to achieve high reaction efficiency. One method of on-chip thermal control is Joule heating in which electrodes are used to heat the fluid inside the module at defined locations. The fluid conductivity may be used as a temperature feedback for power control.

In order to effectively amplify nucleic acids from target components, the microfluidics system may include a cell lysing or viral protein coat-disrupting module to free nucleic acids prior to providing the sample to an amplification module. Cell lysing modules may rely on chemical, thermal, and/or mechanical means to effect cell lysis. Because the cell membrane consists of a lipid double-layer, lysis buffers containing surfactants can solubilize the lipid membranes. Typically, the lysis buffer will be introduced directly to a lysis chamber via an external port so that the cells are not prematurely lysed during sorting or other upstream process. However, in some cases, the target to be sorted from a sample using labeled magnetic particles is only accessible after lysis. In such cases, it may be necessary to include a lysis module upstream from a sorting module. In such cases, the aim of lysis is to release the intracellular organelles and proteins for magnetophoretic separation processes. In cases where organelle integrity is necessary, chemical lysis methods may be inappropriate. Mechanical breakdown of the cell membrane by shear and wear is appropriate in certain applications. Lysis modules relying mechanical techniques may employ various geometric features to effect piercing, shearing, abrading, etc. of cells entering the module. Other types of mechanical breakage such as acoustic techniques may also yield appropriate lysate. Further, thermal energy can also be used to lyse cells such as bacteria, yeasts, and spores. Heating disrupts the cell membrane and the intracellular materials are released. In order to enable subcellular fractionation in microfluidic systems a lysis module may also employ an electrokinetic technique or electroporation. Electroporation creates transient or permanent holes in the cell membranes by application of an external electric field that induces changes in the plasma membrane and disrupts the transmembrane potential. In microfluidic electroporation devices, the membrane may be permanently disrupted, and holes on the cell membranes sustained to release desired intracellular materials released.

When the target is a virus or a component of a virus, it may be necessary to disrupt the viral protein coat at some stage in the microfluidic system. This may be done via thermal or chemical means as described for the lysis chamber, bearing in mind that different conditions may be required to remove or compromise a protein coat. In one example, the genetic contents of a virus are extracted by contact with an SDS (sodium dodecyl sulfate) solution. In certain embodiments, viruses coupled to magnetic particles are temporarily immobilized during sorting and/or extraction/separation of viral genetic materials.

As many viruses are retroviruses (their genetic material is RNA, rather than DNA), it may be necessary to perform reverse transcription in a microfluidic module prior to detection and/or amplification. Reverse transcription may be performed by implemented in a microfluidic module by delivering deoxyribonucleotides, primer, and a reverse transcriptase in a buffer at an appropriate temperature to cause the reverse transcription reaction to proceed. In some cases, reverse transcription and amplification may take place in a single module or station that employs all the necessary components for reverse transcription and amplification. In some embodiments, both processes are implemented by controlling the sequence of delivery of the appropriate nucleosides and enzymes to the station or module.

Many suitable detection techniques are available to detect target or other species in microfluidic modules employed in embodiments of the invention. These techniques may involve signals that are primarily optical, electrical, magnetic, mechanical, etc. A microfluidic detection module may employ continuous flow of the target or it may employ immobilized target as in the case of a nucleic acid microarray. In certain embodiments, fluorescent detection is employed. This of course requires that a fluorophore be coupled to the target species in or upstream from the detection module (unless the fluorophore is present in the native target as would be the cases with an expressed fluorphore such as a green fluorescent protein). In some embodiments, a detection module includes an inlet for receiving a fluorescently labeled antibody or other component specific for the target or a target associated feature such as a binding moiety on a magnetic particle or a particular protein on cell that carries the target. Presence of the fluorophore in the detection module is detected by exciting the molecule or moiety with light of an appropriate excitation frequency and detecting emitted light intensity at a signature emission frequency.

Many other detection techniques useful in a microfluidics environment are known to those of skill in the art. Examples include capacitive techniques, electrochemical techniques, mass detection techniques, and the like.

Additional aspects of the invention include kits, e.g., for use in practicing methods of the invention. In certain embodiments, the kits include one or more tagging agents, such as magnetic tags, e.g., present as bifunctional agents or part of a system of two or more reagents, e.g., as described above, as well as other components (as desired), e.g., buffers, etc., as described above. Also present may be sorting devices, e.g., as described above. Also present may be additional components or reagents that find use in practicing various embodiments subject methods, e.g., reagents employed in pre-and/or post-sorting steps, etc.

The various reagent components and/or devices of the kits may be present in separate containers, or certain components may be combined into a single container of the kit, as desired.

In addition to the above components, the subject kits further include (in certain embodiments) instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Yet another form of these instructions is a computer readable medium, e.g., diskette, compact disk (CD), etc., on which the information has been recorded. Yet another form of these instructions that may be present is a website address which may be used via the interne to access the information at a removed site.

Example

In this example, a microfluidic device was employed to perform magnetophoretic screening of a molecular library in a microfluidic device. Specifically, a 10⁸-member peptide library was screened to identify a consensus sequence of amino acids with affinity towards the target protein (α-FLAG M2 monoclonal antibody).

The bacterial strains used in this work displayed peptides as insertional fusions into the second extracellular loop of outer membrane protein OmpX of E. coli. Streptavidin-coated superparamagnetic microbeads were purchased from Dynal Biotech (M280, Carlsbad, Calif.). Streptavidin R-phycoerythrin was obtained from Molecular Probes (Carlsbad, Calif.), and the biotinylated anti-FLAG M2 antibody was obtained from Sigma.

Micro-magnetic field gradient generators (MFG) were fabricated by electron-beam evaporation of 200-nm nickel on borosilicate glass wafers after an optical lithography and a lift-off process. This involved a blanket deposition a photoresist on the glass wafer, followed by optical exposure to the MFG pattern, development of the resist, and deposition of the nickel by evaporation from a nickel target. Microfluidic vias of diameter approximately a few hundred micrometers were drilled into the glass substrates using a computer-controlled CNC mill (Flashcut CNC, Menlo Park, Calif.). The negative-tone master mold of the microfluidic channels was fabricated on a 4-inch silicon wafer using a deep reactive-ion-etcher (SLR-770, Plasmatherm, St. Petersburg, Fla.), which produced 50 μm deep channels. Subsequently, the PDMS replicas of the silicon master mold were fabricated by applying a precursor (Sylgard 184, Dow-Coming Inc., Midland, Mich.; 10 part base resin: 1 part curing agent) to the silicon master, followed by curing at 70° C. for 3 hours. After dicing the borosilicate glass wafers, the MFC substrate and the PDMS channel were cleaned in acetone and oxidized in a UV-ozone chamber prior to their covalent bonding in a flip-chip aligner (Research Devices M8A, Piscataway, N.J.). Microfluidic inlets and outlets were attached to the device with epoxy. Each microfluidic device was only used once and discarded after each usage to eliminate contamination.

A two stage microfluidic device was utilized to screen a peptide library displayed on the surface of E. coli to isolate the consensus sequence of amino acids that exhibit high affinity binding towards the target molecule (anti-FLAG BioM2 mAb, Sigma). Since the target antibody is biotinylated it binds strongly to streptavidin, and as such, the E. coli clones displaying peptides with affinity for the antibody binding pocket (or affinity for streptavidin directly) become bound to the streptavidin-coated magnetic beads.

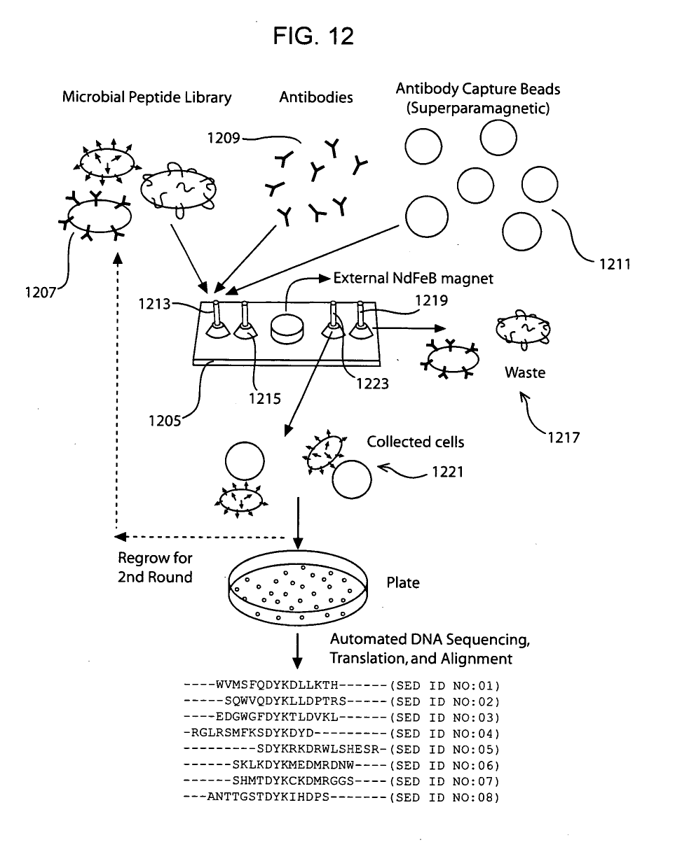

In this example, the bead-captured clones were sorted from the non-binding cells using a two-stage microfluidic device 1205 as depicted in FIG. 12. A bacterial peptide library 1207, antibodies 1209, and superparamagnetic beads 1211 were all provided to a sample inlet port 1213 in device 1205. Buffer was provided through an inlet port 1215. A waste stream containing non-binding library members 1217 exited via a port 1219. Target cells 1221 labeled with the magnetic beads were provided via a collection stream from a port 1223.

Prior to delivering the library to microfluidic device 1205 for positive screening, the initial peptide library (500 μL of cells at 2×10⁹ cells/mL) was de-enriched for streptavidin (SA) binders by incubating with SA-coated magnetic beads (4×10⁷ beads/mL) and negative microfluidic selection. Next, the remaining cells were incubated with biotinylated target protein (α-FLAG M2 monoclonal antibody) at a final concentration of 5 nM at 4C for 1 hour, washed twice in PBS, and incubated with magnetic beads at a concentration of 4×10⁷ beads/mL for positive screening.

To reduce settling of the beads during screening, the density of the solution was adjusted to that of polystyrene beads (1.06 g/ml) by adding glycerol at a final concentration of 20% (vol/vol). Microfluidic interconnections were provided by Tygon tubing (inner diameter of 0.02 inches, Fisher Scientific), which was attached to the inlets and outlets of the device. A pair of NdFeB magnets (5 mm in diameter, K&J magnetics, Jamison, Pa.) was attached to the top and bottom side of the device to externally magnetize the MFGs. The locations of the paired magnets with respect to MFGs were adjusted under a microscope to optimize the sorting performance.

A dual-track programmable syringe pump setup (Harvard Apparatus Ph.D. 2000, Holliston, Md.) delivered both the cell mixture and the sorting buffer into the device at a constant flow rate. The device and the tubing were filled with sorting buffer (1X PBS/20% glycerol/1% BSA) to drive out air bubbles before pumping. The volumetric sample flow rate during sorting was 500-1000 μL/hour, and the buffer flow rate was 2-4 times that of sample flow. The flow of the beads in the microchannel was monitored through an upright, bright-field microscope (DM 4000, LEICA Microsystems AG, Wetzlar, Germany) and a cooled CCD camera (ORCA-AG, Hamamatsu corporation, Bridgewater, N.J.). The enriched cell solution was collected in a microcentrifuge tube. The collected enriched cells were amplified by overnight growth in LB medium with 0.2% glucose. A second round of induction, labeling, negative depletion of SA binders, positive enrichment of target binders, and overnight growth was performed at a reduced cell concentration of 10⁸ cells/mL and 10⁷ beads/mL.

The initial frequency of cells that express target-binding peptides was quantified using flow cytometry after labeling the library with biotinylated target antibody conjugated with a fluorophore (SAPE). This measurement gave the combined frequency of target-binding peptides as well as unwanted subpopulation that simply binds to streptavidin on the magnetic beads. The frequency of SA-binding peptides was independently measured by incubating the library with SAPE. The difference of the two measurements gave the net frequency of target-binding population. Before processing, the frequency of target-binding cells was 0.03% (FIG. 9 top). After the first round of screening, the frequency of target cells reached 0.7% (FIG. 9 middle) and the second round enriched the target cells to 53.6% of the population (FIG. 9 bottom).

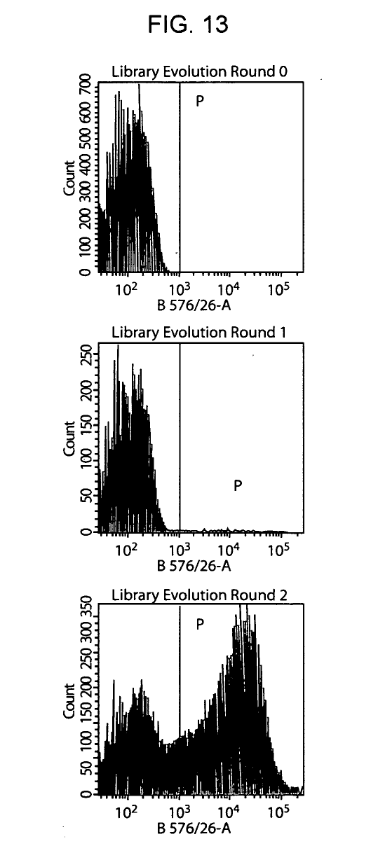

Note that FIG. 13 provides flow cytometric analysis of the selection. The fraction of target-binding population in the library was analyzed by flow cytometry after incubating them with fluorescently labeled target. The intensity of red fluorescence (x-axis) indicates the expression level of target-binding peptides on each cell. (a) Unselected library (b) Following one round of cell sorting, 0.7% of the population exhibit target-binding peptides (c) 23.8% of the population exhibit target-binding peptides after two rounds.

Following the screening, the collected fraction was diluted and spread on agar plates to obtain colonies. Colonies were picked to individual wells of a 96-well microtiter plate, grown overnight in LB medium with 25 ug/ml chloramphenicol and 10% (v/v) glycerol, and then frozen. Template preparation and plasmid sequencing were then carried out by the High-Throughput Genomics Unit (HTGU), Department of Genome Sciences at the University of Washington.

Cell library population analysis was performed with conventional FACS (FACSAria, BD Biosciences, San Jose, Calif.), which was carried out by growing, inducing, and labeling the library with biotinylated anti-FLAG antibody at a final concentration of 5 nM. The cells were then washed twice and incubated on ice with streptavidin-phycoerythrin (60 nM) for 45-60 min. Cells were washed once and resuspended in cold PBS at a final concentration of ˜10⁶ cells/mL and immediately analyzed by flow cytometry. Control samples were prepared in parallel with SAPE labeling, but without antibody labeling, to assay SA binding clones.

A total of 87 sequences were obtained from clones isolated in the second round of sorting. The sequences were aligned using the program AlignX (Invitrogen, Carlsbad, Calif.) employing the ClustalW algorithm. A clear consensus group (21 of 87) contained a strong motif of DYKxxD, the well-established critical motif of the

FLAG epitope. The identification of the consensus motif validates the methodology of epitope mapping. It is also apparent that the streptavidin binding clones were co-enriched and abundant, however, they are easily identified and excluded from the pool of sequences at the data analysis stage because they present the known HPQ or HPM motif (31 of 87 sequences), as well as other known disulfide-constrained motifs (4 of 87). The remaining sequences displayed no consensus, most likely originating from non-specific binding during the screening process. The sequence analysis is in qualitative agreement with the enrichment factors as monitored by flow cytometry.

Conclusion

A number of embodiments of the invention have been described. Nevertheless, it will be understood that various modifications may be made without departing from the spirit and scope of the invention. For example, while a continuous processing/screening mode has been described, other techniques such as a parallel screening or batch screening may be employed in some embodiments. Further, the above description has been focused on biological applications and in particular cell based libraries, but it should also be noted that the same principles apply to other libraries, such as inorganic or non-biological organic materials. Thus, the apparatus and methods described above can also be used to screen non-biological substances in liquids. Accordingly, other embodiments are within the scope of the following claims.

What is claimed is:

1. A method of screening a molecular library for a defined activity or property by using a microfluidic device, the method comprising:
(a) providing a molecular library as an input to the microfluidic device, wherein members of the library possessing the defined activity or property are tagged with a component that responds to magnetic fields;
(b) passing the members of the library through the microfluidic device in a manner that exposes them to a magnetic field at some point during their passage, whereby members of the library tagged with the component that responds to the magnetic field displace relative to their untagged counterparts; and
(c) detecting, amplifying, and/or separating the displaced members of the molecular library.

2. The method of claim 1, wherein (c) comprises detecting members of the library tagged with the component that responds to the magnetic field.

3. The method of claim 1, wherein (c) comprises separating members of the library tagged with the component that responds to the magnetic field from the untagged counterparts.

4. The method of claim 1, wherein at least some of the members of the library are passed serially through the microfluidic device.

5. The method of claim 1, further comprising, prior to exposure to the magnetic field, treating the members of the library with a bi-functional reagent containing (1) a component that selectively binds to members of the library possessing the defined activity or property and (2) a component that is sensitive to magnetic fields.

6. The method of claim 1, further comprising, prior to exposure to the magnetic field, treating the members of the library with (1) a first reagent that binds to members of the library possessing the defined activity or property and (2) a second reagent that is sensitive to magnetic fields.

7. The method of claim 1, wherein the molecular library comprises a population of cells comprising distinct molecular features.

8. The method of claim 1, wherein the molecular library comprises a bacterial-based library or a yeast-based library.

9. The method of claim 1, wherein the molecular library comprises a phage-based library.

10. The method of claim 1, wherein the molecular library comprises a combinatorial library of chemical compounds.

11. The method of claim 1, wherein the molecular library comprises a library of oligomers.

12. The method of claim 1, wherein the molecular library comprises a library of peptides, proteins, or a combination of peptides and proteins.

13. The method of claim 1, wherein the molecular library comprises a library of oligonucleotides, polynucleotides, or a combination of oligonucleotides and polynucleotides.

14. The method of claim 1, wherein the molecular library comprises hybrid molecules.

15. A microfluidics system for screening a molecular library, the microfluidics system comprising:
an input port for receiving the molecular library;
a microfluidic flow passage for passing the molecular library in a fluid medium;
a magnetic field generating component for applying a magnetic field to at least a region of the microfluidic flow passage;
a first region for receiving members of the molecular library substantially deflected by the magnetic field;
a second region for receiving members of the molecular library that are not substantially deflected by the magnetic field; and
a controller designed or configured to direct members of the molecular library through the microfluidic flow passage.

16. The system of claim 15, further comprising a system for generating the molecular library.

17. The system of claim 15, further comprising a system for tagging members of a molecular library possessing the defined activity or property with a component that responds to magnetic fields.

18. The system of claim 17, wherein the system for tagging comprises a bi-functional reagent containing (1) a component that selectively binds to members of the library possessing the defined activity or property and (2) a component that is sensitive to magnetic fields.

19. The system of claim 17, wherein the system for tagging comprises (1) a first reagent that binds to members of the library possessing the defined activity or property and (2) a second reagent that is sensitive to magnetic fields.

20. The system of claim 15, further comprising a detector for detecting members of the library tagged with the component that responds to the magnetic field.

21. The system of claim 15, wherein the magnetic field generating component comprises a plurality of ferromagnetic elements arranged to produce a defined magnetic field gradient within the microfluidic flow passage.

22. The system of claim 21, wherein the magnetic field generating component comprises a permanent magnet proximate the plurality of ferromagnetic elements.

23. The system of claim 21, wherein the magnetic field generating component comprises an electromagnet proximate the plurality of ferromagnetic elements.

24. The system of claim 21, wherein the plurality of ferromagnetic elements are disposed within the microfluidic flow passage.

25. The system of claim 21, wherein the plurality of ferromagnetic elements comprises one or more ferromagnetic strips.

26. The system of claim 21, wherein the plurality of ferromagnetic elements comprises one or more pins or pegs.

27. The system of claim 15, wherein the magnetic field generating component comprises at least two magnetic field gradient generators.

28. The system of claim 27, wherein the at least two magnetic field gradient generators are located in fluid paths for two separate sample streams on opposite sides of a fluid path for a buffer stream.

29. The system of claim 27, wherein the at least two magnetic field gradient generators comprise two permanent magnets shared by the at least two magnetic field gradient generators.

30. A microfluidics system for screening a molecular library for a defined activity or property, the microfluidics system comprising:
(a) means for tagging members of a molecular library possessing the defined activity or property with a component that responds to magnetic fields;
(b) means for providing the molecular library as an input to a microfluidic device;
(c) means for passing the members of the library through the microfluidic device in a manner that exposes them to a magnetic field at some point during their passage, whereby members of the library tagged with the component that responds to the magnetic field displace relative to their untagged counterparts; and
(d) means for detecting or separating the displaced members of the molecular library.

31. The system of claim 30, further comprising means for generating the molecular library.

32. The system of claim 30, further comprising means for generating a magnetic field gradient in a region where the members of the library pass in the microfluidic device.

33. The system of claim 30, wherein the means for tagging comprises a bi-functional reagent containing (1) a component that selectively binds to members of the library possessing the defined activity or property and (2) a component that is sensitive to magnetic fields.

34. The system of claim 30, wherein the means for tagging comprises (1) a first reagent that binds to members of the library possessing the defined activity or property and (2) a second reagent that is sensitive to magnetic fields.

35. The system of claim 30, further comprising a detection means for detecting members of the library tagged with the component that responds to the magnetic field.

36. The system of claim 30, further comprising a detection means for detecting members of the library tagged with the component that respond to the magnetic field.

37. A method of screening a molecular library for a defined activity or property by using a microfluidic device, the method comprising:
(a) providing a molecular library as an input to the microfluidic device, wherein members of the library possessing the defined activity or property are physically associated with a component that responds to magnetic fields;
(b) passing the members of the library through the microfluidic device in a manner that exposes them to a magnetic field at some point during their passage, whereby members of the library physically associated with the component that responds to the magnetic field are activated by the magnetic field relative to their unassociated counterparts; and
(c) detecting or separating the activated members of the molecular library.
